(19) United States
(12) Patent Application Publication
(10) Pub. No.: US 2026/0332273 A1
(43) Pub. Date: Oct. 22, 2026

(54) TRANSMISSION PORT CALIBRATION

(71) Applicant: QUALCOMM INCORPORATED, San Diego, CA (US)

(72) Inventors: Kexin XIAO, Shanghai (CN); Yi HUANG, San Diego, CA (US); Yu ZHANG, San Diego, CA (US); Peter GAAL, San Diego, CA (US); Wanshi CHEN, San Diego, CA (US)

(21) Appl. No.: 19/108,935

(22) PCT Filed: Oct. 14, 2022
(86) PCT No.: PCT/CN2022/125264

§ 371 Date: Mar. 5, 2025

(51) Int. Cl. H04B 17/12; H04B 7/06; H04L 5/00; H04W 72/02; H04W 80/02

(52) U.S. Cl. CPC H04B 17/12; H04B 7/0639; H04L 5/0044; H04L 5/0051; H04W 72/02; H04W 80/02

(57) ABSTRACT

Various aspects of the present disclosure generally relate to wireless communication. In some aspects, a first network node may receive, from a second network node, phase calibration information indicative of a phase error calibration vector corresponding to a phase difference associated with a plurality of transmission ports at the first network node. The first network node may transmit a communication based on the phase calibration information. Numerous other aspects are described.

### FIELD OF THE DISCLOSURE

Aspects of the present disclosure generally relate to wireless communication and to techniques and apparatuses for transmission port calibration.

### BACKGROUND

Wireless communication systems are widely deployed to provide various telecommunication services such as telephony, video, data, messaging, and broadcasts. Typical wireless communication systems may employ multiple-access technologies capable of supporting communication with multiple users by sharing available system resources (e.g., bandwidth, transmit power, or the like). Examples of such multiple-access technologies include code division multiple access (CDMA) systems, time division multiple access (TDMA) systems, frequency division multiple access (FDMA) systems, orthogonal frequency division multiple access (OFDMA) systems, single-carrier frequency division multiple access (SC-FDMA) systems, time division synchronous code division multiple access (TD-SCDMA) systems, and Long Term Evolution (LTE). LTE/LTE-Advanced is a set of enhancements to the Universal Mobile Telecommunications System (UMTS) mobile standard promulgated by the Third Generation Partnership Project (3GPP).

A wireless network may include one or more network nodes that support communication for wireless communication devices, such as a user equipment (UE) or multiple UEs. A UE may communicate with a network node via downlink communications and uplink communications. “Downlink” (or “DL”) refers to a communication link from the network node to the UE, and “uplink” (or “UL”) refers to a communication link from the UE to the network node. Some wireless networks may support device-to-device communication, such as via a local link (e.g., a sidelink (SL), a wireless local area network (WLAN) link, and/or a wireless personal area network (WPAN) link, among other examples).

The above multiple access technologies have been adopted in various telecommunication standards to provide a common protocol that enables different UEs to communicate on a municipal, national, regional, and/or global level. New Radio (NR), which may be referred to as 5G, is a set of enhancements to the LTE mobile standard promulgated by the 3GPP. NR is designed to better support mobile broadband internet access by improving spectral efficiency, lowering costs, improving services, making use of new spectrum, and better integrating with other open standards using orthogonal frequency division multiplexing (OFDM) with a cyclic prefix (CP) (CP-OFDM) on the downlink, using CP-OFDM and/or single-carrier frequency division multiplexing (SC-FDM) (also known as discrete Fourier transform spread OFDM (DFT-s-OFDM)) on the uplink, as well as supporting beamforming, multiple-input multiple-output (MIMO) antenna technology, and carrier aggregation. As the demand for mobile broadband access continues to increase, further improvements in LTE, NR, and other radio access technologies remain useful.

### SUMMARY

Some aspects described herein relate to a first network node for wireless communication. The first network node may include a memory and one or more processors coupled to the memory. The one or more processors may be configured to cause the first network node to receive, from a second network node, phase calibration information indicative of a phase error calibration vector corresponding to a phase difference associated with a plurality of transmission ports at the first network node. The one or more processors may be configured to cause the first network node to transmit a communication based on the phase calibration information.

Some aspects described herein relate to a second network node. The second network node may include a memory and one or more processors coupled to the memory. The one or more processors may be configured to cause the second network node to transmit, to a first network node, phase calibration information indicative of a phase error calibration vector corresponding to a phase difference associated with a plurality of transmission ports at the first network node. The one or more processors may be configured to cause the second network node to receive a communication based on the phase calibration information.

Some aspects described herein relate to a method of wireless communication performed by an apparatus at a first network node. The method may include receiving, from a second network node, phase calibration information indicative of a phase error calibration vector corresponding to a phase difference associated with a plurality of transmission ports at the first network node. The method may include transmitting a communication based on the phase calibration information.

Some aspects described herein relate to a method of wireless communication performed by an apparatus at a second network node. The method may include transmitting, to a first network node, phase calibration information indicative of a phase error calibration vector corresponding to a phase difference associated with a plurality of transmission ports at the first network node. The method may include receiving a communication based on the phase calibration information.

Some aspects described herein relate to a non-transitory computer-readable medium that stores a set of instructions for wireless communication by a first network node. The set of instructions, when executed by one or more processors of the first network node, may cause the first network node to receive, from a second network node, phase calibration information indicative of a phase error calibration vector corresponding to a phase difference associated with a plurality of transmission ports at the first network node. The set of instructions, when executed by one or more processors of the first network node, may cause the first network node to transmit a communication based on the phase calibration information.

Some aspects described herein relate to a non-transitory computer-readable medium that stores a set of instructions for wireless communication by a second network node. The set of instructions, when executed by one or more processors of the second network node, may cause the second network node to transmit, to a first network node, phase calibration information indicative of a phase error calibration vector corresponding to a phase difference associated with a plurality of transmission ports at the first network node. The set of instructions, when executed by one or more processors of the second network node, may cause the second network node to receive a communication based on the phase calibration information.

Some aspects described herein relate to an apparatus for wireless communication. The apparatus may include means for receiving, from a network node, phase calibration information indicative of a phase error calibration vector corresponding to a phase difference associated with a plurality of transmission ports at the apparatus. The apparatus may include means for transmitting a communication based on the phase calibration information.

Some aspects described herein relate to an apparatus for wireless communication. The apparatus may include means for transmitting, to a network node, phase calibration information indicative of a phase error calibration vector corresponding to a phase difference associated with a plurality of transmission ports at the network node. The apparatus may include means for receiving a communication based on the phase calibration information.

Aspects generally include a method, apparatus, system, computer program product, non-transitory computer-readable medium, user equipment, base station, network entity, network node, wireless communication device, and/or processing system as substantially described herein with reference to and as illustrated by the drawings and specification.

The foregoing has outlined rather broadly the features and technical advantages of examples according to the disclosure in order that the detailed description that follows may be better understood. Additional features and advantages will be described hereinafter. The conception and specific examples disclosed may be readily utilized as a basis for modifying or designing other structures for carrying out the same purposes of the present disclosure. Such equivalent constructions do not depart from the scope of the appended claims. Characteristics of the concepts disclosed herein, both their organization and method of operation, together with associated advantages, will be better understood from the following description when considered in connection with the accompanying figures. Each of the figures is provided for the purposes of illustration and description, and not as a definition of the limits of the claims.

While aspects are described in the present disclosure by illustration to some examples, those skilled in the art will understand that such aspects may be implemented in many different arrangements and scenarios. Techniques described herein may be implemented using different platform types, devices, systems, shapes, sizes, and/or packaging arrangements. For example, some aspects may be implemented via integrated chip embodiments or other non-module-component based devices (e.g., end-user devices, vehicles, communication devices, computing devices, industrial equipment, retail/purchasing devices, medical devices, and/or artificial intelligence devices). Aspects may be implemented in chip-level components, modular components, non-modular components, non-chip-level components, device-level components, and/or system-level components. Devices incorporating described aspects and features may include additional components and features for implementation and practice of claimed and described aspects. For example, transmission and reception of wireless signals may include one or more components for analog and digital purposes (e.g., hardware components including antennas, radio frequency (RF) chains, power amplifiers, modulators, buffers, processors, interleavers, adders, and/or summers). It is intended that aspects described herein may be practiced in a wide variety of devices, components, systems, distributed arrangements, and/or end-user devices of varying size, shape, and constitution.

### BRIEF DESCRIPTION OF THE DRAWINGS

So that the above-recited features of the present disclosure can be understood in detail, a more particular description, briefly summarized above, may be had by reference to aspects, some of which are illustrated in the appended drawings. It is to be noted, however, that the appended drawings illustrate only certain typical aspects of this disclosure and are therefore not to be considered limiting of its scope, for the description may admit to other equally effective aspects. The same reference numbers in different drawings may identify the same or similar elements.

FIG. 1 is a diagram illustrating an example of a wireless network, in accordance with the present disclosure.

FIG. 2 is a diagram illustrating an example of a network node in communication with a user equipment (UE) in a wireless network, in accordance with the present disclosure.

FIG. 3 is a diagram illustrating an example disaggregated base station architecture, in accordance with the present disclosure.

FIG. 4 is a diagram illustrating an example of sounding reference signal (SRS) resource sets, in accordance with various aspects of the present disclosure.

FIG. 5 is a diagram illustrating an example associated with codebook-based physical uplink shared channel (PUSCH) communications, in accordance with the present disclosure.

FIG. 6 is a flow diagram illustrating an example of codebook-based uplink communication, in accordance with the present disclosure.

FIG. 7 is a diagram illustrating an example process performed, for example, by a first network node, in accordance with the present disclosure.

FIG. 8 is a diagram illustrating an example process performed, for example, by a second network node, in accordance with the present disclosure.

FIG. 9 is a diagram of an example apparatus for wireless communication, in accordance with the present disclosure.

### DETAILED DESCRIPTION

Various aspects of the disclosure are described more fully hereinafter with reference to the accompanying drawings. This disclosure may, however, be embodied in many different forms and should not be construed as limited to any specific structure or function presented throughout this disclosure. Rather, these aspects are provided so that this disclosure will be thorough and complete, and will fully convey the scope of the disclosure to those skilled in the art. One skilled in the art should appreciate that the scope of the disclosure is intended to cover any aspect of the disclosure disclosed herein, whether implemented independently of or combined with any other aspect of the disclosure. For example, an apparatus may be implemented or a method may be practiced using any number of the aspects set forth herein. In addition, the scope of the disclosure is intended to cover such an apparatus or method which is practiced using other structure, functionality, or structure and functionality in addition to or other than the various aspects of the disclosure set forth herein. It should be understood that any aspect of the disclosure disclosed herein may be embodied by one or more elements of a claim.

Aspects and examples generally include a method, apparatus, network node, system, computer program product, non-transitory computer-readable medium, user equipment, base station, wireless communication device, and/or processing system as described or substantially described herein with reference to and as illustrated by the drawings and specification.

This disclosure may be readily utilized as a basis for modifying or designing other structures for carrying out the same purposes of the present disclosure. Such equivalent constructions do not depart from the scope of the appended claims. Characteristics of the concepts disclosed herein, both their organization and method of operation, together with associated advantages, are better understood from the following description when considered in connection with the accompanying figures. Each of the figures is provided for the purposes of illustration and description, and not as a definition of the limits of the claims.

While aspects are described in the present disclosure by illustration to some examples, such aspects may be implemented in many different arrangements and scenarios. Techniques described herein may be implemented using different platform types, devices, systems, shapes, sizes, and/or packaging arrangements. For example, some aspects may be implemented via integrated chip embodiments or other non-module-component-based devices (e.g., end-user devices, vehicles, communication devices, computing devices, industrial equipment, retail/purchasing devices, medical devices, and/or artificial intelligence devices). Aspects may be implemented in chip-level components, modular components, non-modular components, non-chip-level components, device-level components, and/or system-level components. Devices incorporating described aspects and features may include additional components and features for implementation and practice of claimed and described aspects. For example, transmission and reception of wireless signals may include one or more components for analog and digital purposes (e.g., hardware components including antennas, radio frequency (RF) chains, power amplifiers, modulators, buffers, processors, interleavers, adders, and/or summers). Aspects described herein may be practiced in a wide variety of devices, components, systems, distributed arrangements, and/or end-user devices of varying size, shape, and constitution.

Several aspects of telecommunication systems will now be presented with reference to various apparatuses and techniques. These apparatuses and techniques will be described in the following detailed description and illustrated in the accompanying drawings by various blocks, modules, components, circuits, steps, processes, algorithms, or the like (collectively referred to as “elements”). These elements may be implemented using hardware, software, or combinations thereof. Whether such elements are implemented as hardware or software depends upon the particular application and design constraints imposed on the overall system.

While aspects may be described herein using terminology commonly associated with a 5G or New Radio (NR) radio access technology (RAT), aspects of the present disclosure can be applied to other RATs, such as a 3G RAT, a 4G RAT, and/or a RAT subsequent to 5G (e.g., 6G).

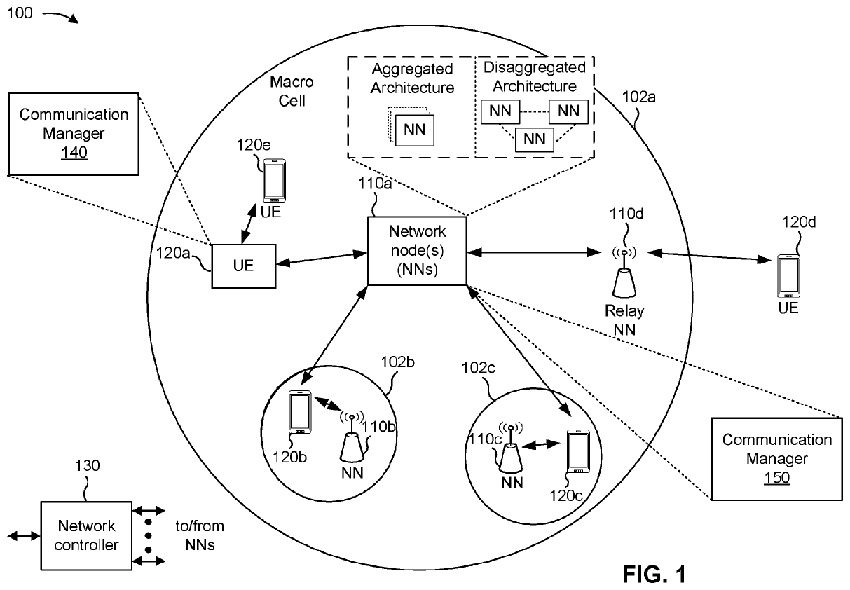

FIG. 1 is a diagram illustrating an example of a wireless network 100, in accordance with the present disclosure. The wireless network 100 may be or may include elements of a 5G (e.g., NR) network and/or a 4G (e.g., Long Term Evolution (LTE)) network, among other examples. The wireless network 100 may include one or more network nodes 110 (shown as a network node 110a, a network node 110b, a network node 110c, and a network node 110d), a user equipment (UE) 120 or multiple UEs 120 (shown as a UE 120a, a UE 120b, a UE 120c, a UE 120d, and a UE 120e), and/or other entities. A network node 110 is a network node that communicates with UEs 120. As shown, a network node 110 may include one or more network nodes. For example, a network node 110 may be an aggregated network node, meaning that the aggregated network node is configured to utilize a radio protocol stack that is physically or logically integrated within a single radio access network (RAN) node (e.g., within a single device or unit). As another example, a network node 110 may be a disaggregated network node (sometimes referred to as a disaggregated base station), meaning that the network node 110 is configured to utilize a protocol stack that is physically or logically distributed among two or more nodes (such as one or more central units (CUs), one or more distributed units (DUs), or one or more radio units (RUs)).

In some examples, a network node 110 is or includes a network node that communicates with UEs 120 via a radio access link, such as an RU. In some examples, a network node 110 is or includes a network node that communicates with other network nodes 110 via a fronthaul link or a midhaul link, such as a DU. In some examples, a network node 110 is or includes a network node that communicates with other network nodes 110 via a midhaul link or a core network via a backhaul link, such as a CU. In some examples, a network node 110 (such as an aggregated network node 110 or a disaggregated network node 110) may include multiple network nodes, such as one or more RUs, one or more CUs, and/or one or more DUs. A network node 110 may include, for example, an NR base station, an LTE base station, a Node B, an eNB (e.g., in 4G), a gNB (e.g., in 5G), an access point, a transmission reception point (TRP), a DU, an RU, a CU, a mobility element of a network, a core network node, a network element, a network equipment, a RAN node, or a combination thereof. In some examples, the network nodes 110 may be interconnected to one another or to one or more other network nodes 110 in the wireless network 100 through various types of fronthaul, midhaul, and/or backhaul interfaces, such as a direct physical connection, an air interface, or a virtual network, using any suitable transport network.

In some examples, a network node 110 may provide communication coverage for a particular geographic area. In the Third Generation Partnership Project (3GPP), the term “cell” can refer to a coverage area of a network node 110 and/or a network node subsystem serving this coverage area, depending on the context in which the term is used. A network node 110 may provide communication coverage for a macro cell, a pico cell, a femto cell, and/or another type of cell. A macro cell may cover a relatively large geographic area (e.g., several kilometers in radius) and may allow unrestricted access by UEs 120 with service subscriptions. A pico cell may cover a relatively small geographic area and may allow unrestricted access by UEs 120 with service subscriptions. A femto cell may cover a relatively small geographic area (e.g., a home) and may allow restricted access by UEs 120 having association with the femto cell (e.g., UEs 120 in a closed subscriber group (CSG)). A network node 110 for a macro cell may be referred to as a macro network node. A network node 110 for a pico cell may be referred to as a pico network node. A network node 110 for a femto cell may be referred to as a femto network node or an in-home network node. In the example shown in FIG. 1, the network node 110a may be a macro network node for a macro cell 102a, the network node 110b may be a pico network node for a pico cell 102b, and the network node 110c may be a femto network node for a femto cell 102c. A network node may support one or multiple (e.g., three) cells. In some examples, a cell may not necessarily be stationary, and the geographic area of the cell may move according to the location of a network node 110 that is mobile (e.g., a mobile network node).

In some aspects, the term “base station” or “network node” may refer to an aggregated base station, a disaggregated base station, an integrated access and backhaul (IAB) node, a relay node, or one or more components thereof. For example, in some aspects, “base station” or “network node” may refer to a CU, a DU, an RU, a Near-Real Time (Near-RT) RAN Intelligent Controller (RIC), or a Non-Real Time (Non-RT) RIC, or a combination thereof. In some aspects, the term “base station” or “network node” may refer to one device configured to perform one or more functions, such as those described herein in connection with the network node 110. In some aspects, the term “base station” or “network node” may refer to a plurality of devices configured to perform the one or more functions. For example, in some distributed systems, each of a quantity of different devices (which may be located in the same geographic location or in different geographic locations) may be configured to perform at least a portion of a function, or to duplicate performance of at least a portion of the function, and the term “base station” or “network node” may refer to any one or more of those different devices. In some aspects, the term “base station” or “network node” may refer to one or more virtual base stations or one or more virtual base station functions. For example, in some aspects, two or more base station functions may be instantiated on a single device. In some aspects, the term “base station” or “network node” may refer to one of the base station functions and not another. In this way, a single device may include more than one base station.

The wireless network 100 may include one or more relay stations. A relay station is a network node that can receive a transmission of data from an upstream node (e.g., a network node 110 or a UE 120) and send a transmission of the data to a downstream node (e.g., a UE 120 or a network node 110). A relay station may be a UE 120 that can relay transmissions for other UEs 120. In the example shown in FIG. 1, the network node 110d (e.g., a relay network node) may communicate with the network node 110a (e.g., a macro network node) and the UE 120d in order to facilitate communication between the network node 110a and the UE 120d. A network node 110 that relays communications may be referred to as a relay station, a relay base station, a relay network node, a relay node, a relay, or the like.

The wireless network 100 may be a heterogeneous network that includes network nodes 110 of different types, such as macro network nodes, pico network nodes, femto network nodes, relay network nodes, or the like. These different types of network nodes 110 may have different transmit power levels, different coverage areas, and/or different impacts on interference in the wireless network 100. For example, macro network nodes may have a high transmit power level (e.g., 5 to 40 watts) whereas pico network nodes, femto network nodes, and relay network nodes may have lower transmit power levels (e.g., 0.1 to 2 watts).

A network controller 130 may couple to or communicate with a set of network nodes 110 and may provide coordination and control for these network nodes 110. The network controller 130 may communicate with the network nodes 110 via a backhaul communication link or a midhaul communication link. The network nodes 110 may communicate with one another directly or indirectly via a wireless or wireline backhaul communication link. In some aspects, the network controller 130 may be a CU or a core network device, or may include a CU or a core network device.

The UEs 120 may be dispersed throughout the wireless network 100, and each UE 120 may be stationary or mobile. A UE 120 may include, for example, an access terminal, a terminal, a mobile station, and/or a subscriber unit. A UE 120 may be a cellular phone (e.g., a smart phone), a personal digital assistant (PDA), a wireless modem, a wireless communication device, a handheld device, a laptop computer, a cordless phone, a wireless local loop (WLL) station, a tablet, a camera, a gaming device, a netbook, a smartbook, an ultrabook, a medical device, a biometric device, a wearable device (e.g., a smart watch, smart clothing, smart glasses, a smart wristband, smart jewelry (e.g., a smart ring or a smart bracelet)), an entertainment device (e.g., a music device, a video device, and/or a satellite radio), a vehicular component or sensor, a smart meter/sensor, industrial manufacturing equipment, a global positioning system device, a UE function of a network node, and/or any other suitable device that is configured to communicate via a wireless or wired medium.

Some UEs 120 may be considered machine-type communication (MTC) or evolved or enhanced machine-type communication (eMTC) UEs. An MTC UE and/or an eMTC UE may include, for example, a robot, a drone, a remote device, a sensor, a meter, a monitor, and/or a location tag, that may communicate with a network node, another device (e.g., a remote device), or some other entity. Some UEs 120 may be considered Internet-of-Things (IoT) devices, and/or may be implemented as NB-IoT (narrowband IoT) devices. Some UEs 120 may be considered a Customer Premises Equipment. A UE 120 may be included inside a housing that houses components of the UE 120, such as processor components and/or memory components. In some examples, the processor components and the memory components may be coupled together. For example, the processor components (e.g., one or more processors) and the memory components (e.g., a memory) may be operatively coupled, communicatively coupled, electronically coupled, and/or electrically coupled.

In general, any number of wireless networks 100 may be deployed in a given geographic area. Each wireless network 100 may support a particular RAT and may operate on one or more frequencies. A RAT may be referred to as a radio technology, an air interface, or the like. A frequency may be referred to as a carrier, a frequency channel, or the like. Each frequency may support a single RAT in a given geographic area in order to avoid interference between wireless networks of different RATs. In some cases, NR or 5G RAT networks may be deployed.

In some examples, two or more UEs 120 (e.g., shown as UE 120a and UE 120e) may communicate directly using one or more sidelink channels (e.g., without using a network node 110 as an intermediary to communicate with one another). For example, the UEs 120 may communicate using peer-to-peer (P2P) communications, device-to-device (D2D) communications, a vehicle-to-everything (V2X) protocol (e.g., which may include a vehicle-to-vehicle (V2V) protocol, a vehicle-to-infrastructure (V2I) protocol, or a vehicle-to-pedestrian (V2P) protocol), and/or a mesh network. In such examples, a UE 120 may perform scheduling operations, resource selection operations, and/or other operations described elsewhere herein as being performed by the network node 110.

Devices of the wireless network 100 may communicate using the electromagnetic spectrum, which may be subdivided by frequency or wavelength into various classes, bands, channels, or the like. For example, devices of the wireless network 100 may communicate using one or more operating bands. In 5G NR, two initial operating bands have been identified as frequency range designations FR1 (410 MHz-7.125 GHz) and FR2 (24.25 GHz-52.6 GHz). It should be understood that although a portion of FR1 is greater than 6 GHz, FR1 is often referred to (interchangeably) as a “Sub-6 GHz” band in various documents and articles. A similar nomenclature issue sometimes occurs with regard to FR2, which is often referred to (interchangeably) as a “millimeter wave” band in documents and articles, despite being different from the extremely high frequency (EHF) band (30 GHz-300 GHz) which is identified by the International Telecommunications Union (ITU) as a “millimeter wave” band.

The frequencies between FR1 and FR2 are often referred to as mid-band frequencies. Recent 5G NR studies have identified an operating band for these mid-band frequencies as frequency range designation FR3 (7.125 GHz-24.25 GHz). Frequency bands falling within FR3 may inherit FR1 characteristics and/or FR2 characteristics, and thus may effectively extend features of FR1 and/or FR2 into mid-band frequencies. In addition, higher frequency bands are currently being explored to extend 5G NR operation beyond 52.6 GHz. For example, three higher operating bands have been identified as frequency range designations FR4a or FR4-1 (52.6 GHz-71 GHz), FR4 (52.6 GHz-114.25 GHZ), and FR5 (114.25 GHz-300 GHz). Each of these higher frequency bands falls within the EHF band.

With the above examples in mind, unless specifically stated otherwise, it should be understood that the term “sub-6 GHz” or the like, if used herein, may broadly represent frequencies that may be less than 6 GHz, may be within FR1, or may include mid-band frequencies. Further, unless specifically stated otherwise, it should be understood that the term “millimeter wave” or the like, if used herein, may broadly represent frequencies that may include mid-band frequencies, may be within FR2, FR4, FR4-a or FR4-1, and/or FR5, or may be within the EHF band. It is contemplated that the frequencies included in these operating bands (e.g., FR1, FR2, FR3, FR4, FR4-a, FR4-1, and/or FR5) may be modified, and techniques described herein are applicable to those modified frequency ranges.

In some aspects, a first network node (e.g., the UE 120 or the network node 110) may include a communication manager 140 and/or a communication manager 150. As described in more detail elsewhere herein, the communication manager 140 and/or 150 may receive, from a second network node, phase calibration information indicative of a phase error calibration vector corresponding to a phase difference associated with a plurality of transmission ports at the first network node; and transmit a communication based on the phase calibration information. Additionally, or alternatively, the communication manager 140 and/or 150 may perform one or more other operations described herein.

In some aspects, a second network node (e.g., the UE 120 or the network node 110) may include the communication manager 140 and/or the communication manager 150. As described in more detail elsewhere herein, the communication manager 140 and/or 150 may transmit, to a first network node, phase calibration information indicative of a phase error calibration vector corresponding to a phase difference associated with a plurality of transmission ports at the first network node; and receive a communication based on the phase calibration information. Additionally, or alternatively, the communication manager 140 and/or 150 may perform one or more other operations described herein.

As indicated above, FIG. 1 is provided as an example. Other examples may differ from what is described with regard to FIG. 1.

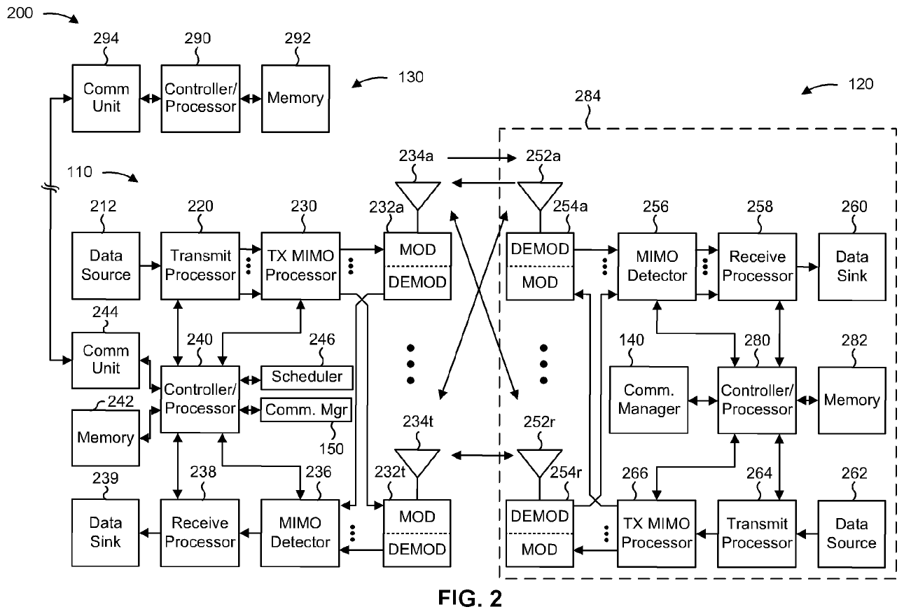

FIG. 2 is a diagram illustrating an example 200 of a network node 110 in communication with a UE 120 in a wireless network 100, in accordance with the present disclosure. The network node 110 may be equipped with a set of antennas 234a through 234t, such as T antennas (T≥1). The UE 120 may be equipped with a set of antennas 252a through 252r, such as R antennas (R≥1). The network node 110 of example 200 includes one or more radio frequency components, such as antennas 234 and a modem 254. In some examples, a network node 110 may include an interface, a communication component, or another component that facilitates communication with the UE 120 or another network node. Some network nodes 110 may not include radio frequency components that facilitate direct communication with the UE 120, such as one or more CUs, or one or more DUs.

At the network node 110, a transmit processor 220 may receive data, from a data source 212, intended for the UE 120 (or a set of UEs 120). The transmit processor 220 may select one or more modulation and coding schemes (MCSs) for the UE 120 based at least in part on one or more channel quality indicators (CQIs) received from that UE 120. The network node 110 may process (e.g., encode and modulate) the data for the UE 120 based at least in part on the MCS(s) selected for the UE 120 and may provide data symbols for the UE 120. The transmit processor 220 may process system information (e.g., for semi-static resource partitioning information (SRPI)) and control information (e.g., CQI requests, grants, and/or upper layer signaling) and provide overhead symbols and control symbols. The transmit processor 220 may generate reference symbols for reference signals (e.g., a cell-specific reference signal (CRS) or a demodulation reference signal (DMRS)) and synchronization signals (e.g., a primary synchronization signal (PSS) or a secondary synchronization signal (SSS)). A transmit (TX) multiple-input multiple-output (MIMO) processor 230 may perform spatial processing (e.g., precoding) on the data symbols, the control symbols, the overhead symbols, and/or the reference symbols, if applicable, and may provide a set of output symbol streams (e.g., T output symbol streams) to a corresponding set of modems 232 (e.g., T′ modems), shown as modems 232a through 232t. For example, each output symbol stream may be provided to a modulator component (shown as MOD) of a modem 232. Each modem 232 may use a respective modulator component to process a respective output symbol stream (e.g., for OFDM) to obtain an output sample stream. Each modem 232 may further use a respective modulator component to process (e.g., convert to analog, amplify, filter, and/or upconvert) the output sample stream to obtain a downlink signal. The modems 232a through 232t may transmit a set of downlink signals (e.g., T downlink signals) via a corresponding set of antennas 234 (e.g., T′ antennas), shown as antennas 234a through 234t.

At the UE 120, a set of antennas 252 (shown as antennas 252a through 252r) may receive the downlink signals from the network node 110 and/or other network nodes 110 and may provide a set of received signals (e.g., R received signals) to a set of modems 254 (e.g., R modems), shown as modems 254a through 254r. For example, each received signal may be provided to a demodulator component (shown as DEMOD) of a modem 254. Each modem 254 may use a respective demodulator component to condition (e.g., filter, amplify, downconvert, and/or digitize) a received signal to obtain input samples. Each modem 254 may use a demodulator component to further process the input samples (e.g., for OFDM) to obtain received symbols. A MIMO detector 256 may obtain received symbols from the modems 254, may perform MIMO detection on the received symbols if applicable, and may provide detected symbols. A receive processor 258 may process (e.g., demodulate and decode) the detected symbols, may provide decoded data for the UE 120 to a data sink 260, and may provide decoded control information and system information to a controller/processor 280. The term “controller/processor” may refer to one or more controllers, one or more processors, or a combination thereof. A channel processor may determine a reference signal received power (RSRP) parameter, a received signal strength indicator (RSSI) parameter, a reference signal received quality (RSRQ) parameter, and/or a CQI parameter, among other examples. In some examples, one or more components of the UE 120 may be included in a housing 284.

The network controller 130 may include a communication unit 294, a controller/processor 290, and a memory 292. The network controller 130 may include, for example, one or more devices in a core network. The network controller 130 may communicate with the network node 110 via the communication unit 294.

One or more antennas (e.g., antennas 234a through 234t and/or antennas 252a through 252r) may include, or may be included within, one or more antenna panels, one or more antenna groups, one or more sets of antenna elements, and/or one or more antenna arrays, among other examples. An antenna panel, an antenna group, a set of antenna elements, and/or an antenna array may include one or more antenna elements (within a single housing or multiple housings), a set of coplanar antenna elements, a set of non-coplanar antenna elements, and/or one or more antenna elements coupled to one or more transmission and/or reception components, such as one or more components of FIG. 2.

Each of the antenna elements may include one or more sub-elements for radiating or receiving radio frequency signals. For example, a single antenna element may include a first sub-element cross-polarized with a second sub-element that can be used to independently transmit cross-polarized signals. The antenna elements may include patch antennas, dipole antennas, or other types of antennas arranged in a linear pattern, a two-dimensional pattern, or another pattern. A spacing between antenna elements may be such that signals with a desired wavelength transmitted separately by the antenna elements may interact or interfere (e.g., to form a desired beam). For example, given an expected range of wavelengths or frequencies, the spacing may provide a quarter wavelength, half wavelength, or other fraction of a wavelength of spacing between neighboring antenna elements to allow for interaction or interference of signals transmitted by the separate antenna elements within that expected range.

Antenna elements and/or sub-elements may be used to generate beams. “Beam” may refer to a directional transmission such as a wireless signal that is transmitted in a direction of a receiving device. A beam may include a directional signal, a direction associated with a signal, a set of directional resources associated with a signal (e.g., angle of arrival, horizontal direction, vertical direction), and/or a set of parameters that indicate one or more aspects of a directional signal, a direction associated with a signal, and/or a set of directional resources associated with a signal.

As indicated above, antenna elements and/or sub-elements may be used to generate beams. For example, antenna elements may be individually selected or deselected for transmission of a signal (or signals) by controlling an amplitude of one or more corresponding amplifiers. Beamforming includes generation of a beam using multiple signals on different antenna elements, where one or more, or all, of the multiple signals are shifted in phase relative to each other. The formed beam may carry physical or higher layer reference signals or information. As each signal of the multiple signals is radiated from a respective antenna element, the radiated signals interact, interfere (constructive and destructive interference), and amplify each other to form a resulting beam. The shape (such as the amplitude, width, and/or presence of side lobes) and the direction (such as an angle of the beam relative to a surface of an antenna array) can be dynamically controlled by modifying the phase shifts or phase offsets of the multiple signals relative to each other.

Beamforming may be used for communications between a UE and a network node, such as for millimeter wave communications and/or the like. In such a case, the network node may provide the UE with a configuration of transmission configuration indicator (TCI) states that respectively indicate beams that may be used by the UE, such as for receiving a physical downlink shared channel (PDSCH). A TCI state indicates a spatial parameter for a communication. For example, a TCI state for a communication may identify a source signal (such as a synchronization signal block, a channel state information reference signal, or the like) and a spatial parameter to be derived from the source signal for the purpose of transmitting or receiving the communication. For example, the TCI state may indicate a quasi-co-location (QCL) type. A QCL type may indicate one or more spatial parameters to be derived from the source signal. The source signal may be referred to as a QCL source. The network node may indicate an activated TCI state to the UE, which the UE may use to select a beam for receiving the PDSCH.

A beam indication may be, or include, a TCI state information element, a beam identifier (ID), spatial relation information, a TCI state ID, a closed loop index, a panel ID, a TRP ID, and/or a sounding reference signal (SRS) set ID, among other examples. A TCI state information element (referred to as a TCI state herein) may indicate information associated with a beam such as a downlink beam. For example, the TCI state information element may indicate a TCI state identification (e.g., a tci-StateID), a QCL type (e.g., a qcl-Type1, qcl-Type2, qcl-TypeA, qcl-TypeB, qcl-TypeC, qcl-TypeD, and/or the like), a cell identification (e.g., a ServCellIndex), a bandwidth part identification (bwp-Id), a reference signal identification such as a CSI-RS (e.g., an NZP-CSI-RS-ResourceId, an SSB-Index, and/or the like), and/or the like. Spatial relation information may similarly indicate information associated with an uplink beam.

The beam indication may be a joint or separate downlink (DL)/uplink (UL) beam indication in a unified TCI framework. In some cases, the network may support layer 1 (L1)-based beam indication using at least UE-specific (unicast) downlink control information (DCI) to indicate joint or separate DL/UL beam indications from active TCI states. In some cases, existing DCI formats 1_1 and/or 1_2 may be reused for beam indication. The network may include a support mechanism for a UE to acknowledge successful decoding of a beam indication. For example, the acknowledgment/negative acknowledgment (ACK/NACK) of the PDSCH scheduled by the DCI carrying the beam indication may be also used as an ACK for the DCI.

Beam indications may be provided for carrier aggregation (CA) scenarios. In a unified TCI framework, information the network may support common TCI state ID update and activation to provide common QCL and/or common UL transmission spatial filter or filters across a set of configured component carriers (CCs). This type of beam indication may apply to intra-band CA, as well as to joint DL/UL and separate DL/UL beam indications. The common TCI state ID may imply that one reference signal (RS) determined according to the TCI state(s) indicated by a common TCI state ID is used to provide QCL Type-D indication and to determine UL transmission spatial filters across the set of configured CCs.

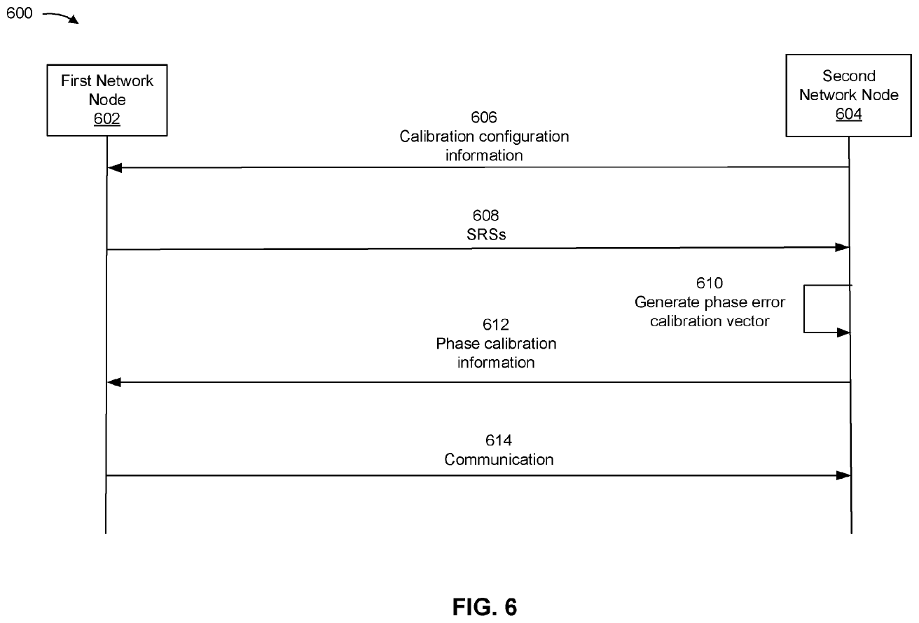

On the uplink, at the UE 120, a transmit processor 264 may receive and process data from a data source 262 and control information (e.g., for reports that include RSRP, RSSI, RSRQ, and/or CQI) from the controller/processor 280. The transmit processor 264 may generate reference symbols for one or more reference signals. The symbols from the transmit processor 264 may be precoded by a TX MIMO processor 266 if applicable, further processed by the modems 254 (e.g., for DFT-s-OFDM or CP-OFDM), and transmitted to the network node 110. In some examples, the modem 254 of the UE 120 may include a modulator and a demodulator. In some examples, the UE 120 includes a transceiver. The transceiver may include any combination of the antenna(s) 252, the modem(s) 254, the MIMO detector 256, the receive processor 258, the transmit processor 264, and/or the TX MIMO processor 266. The transceiver may be used by a processor (e.g., the controller/processor 280) and the memory 282 to perform aspects of any of the methods described herein (e.g., with reference to FIGS. 6-9).

At the network node 110, the uplink signals from UE 120 and/or other UEs may be received by the antennas 234, processed by the modem 232 (e.g., a demodulator component, shown as DEMOD, of the modem 232), detected by a MIMO detector 236 if applicable, and further processed by a receive processor 238 to obtain decoded data and control information sent by the UE 120. The receive processor 238 may provide the decoded data to a data sink 239 and provide the decoded control information to the controller/processor 240. The network node 110 may include a communication unit 244 and may communicate with the network controller 130 via the communication unit 244. The network node 110 may include a scheduler 246 to schedule one or more UEs 120 for downlink and/or uplink communications. In some examples, the modem 232 of the network node 110 may include a modulator and a demodulator. In some examples, the network node 110 includes a transceiver. The transceiver may include any combination of the antenna(s) 234, the modem(s) 232, the MIMO detector 236, the receive processor 238, the transmit processor 220, and/or the TX MIMO processor 230. The transceiver may be used by a processor (e.g., the controller/processor 240) and the memory 242 to perform aspects of any of the methods described herein (e.g., with reference to FIGS. 6-9).

In some aspects, the controller/processor 280 may be a component of a processing system. A processing system may generally be a system or a series of machines or components that receives inputs and processes the inputs to produce a set of outputs (which may be passed to other systems or components of, for example, the UE 120). For example, a processing system of the UE 120 may be a system that includes the various other components or subcomponents of the UE 120.

The processing system of the UE 120 may interface with one or more other components of the UE 120, may process information received from one or more other components (such as inputs or signals), or may output information to one or more other components. For example, a chip or modem of the UE 120 may include a processing system, a first interface to receive or obtain information, and a second interface to output, transmit, or provide information. In some examples, the first interface may be an interface between the processing system of the chip or modem and a receiver, such that the UE 120 may receive information or signal inputs, and the information may be passed to the processing system. In some examples, the second interface may be an interface between the processing system of the chip or modem and a transmitter, such that the UE 120 may transmit information output from the chip or modem. A person having ordinary skill in the art will readily recognize that the second interface also may obtain or receive information or signal inputs, and the first interface also may output, transmit, or provide information.

In some aspects, the controller/processor 240 may be a component of a processing system. A processing system may generally be a system or a series of machines or components that receives inputs and processes the inputs to produce a set of outputs (which may be passed to other systems or components of, for example, the network node 110). For example, a processing system of the network node 110 may be a system that includes the various other components or subcomponents of the network node 110.

The processing system of the network node 110 may interface with one or more other components of the network node 110, may process information received from one or more other components (such as inputs or signals), or may output information to one or more other components. For example, a chip or modem of the network node 110 may include a processing system, a first interface to receive or obtain information, and a second interface to output, transmit, or provide information. In some examples, the first interface may be an interface between the processing system of the chip or modem and a receiver, such that the network node 110 may receive information or signal inputs, and the information may be passed to the processing system. In some examples, the second interface may be an interface between the processing system of the chip or modem and a transmitter, such that the network node 110 may transmit information output from the chip or modem. A person having ordinary skill in the art will readily recognize that the second interface also may obtain or receive information or signal inputs, and the first interface also may output, transmit, or provide information.

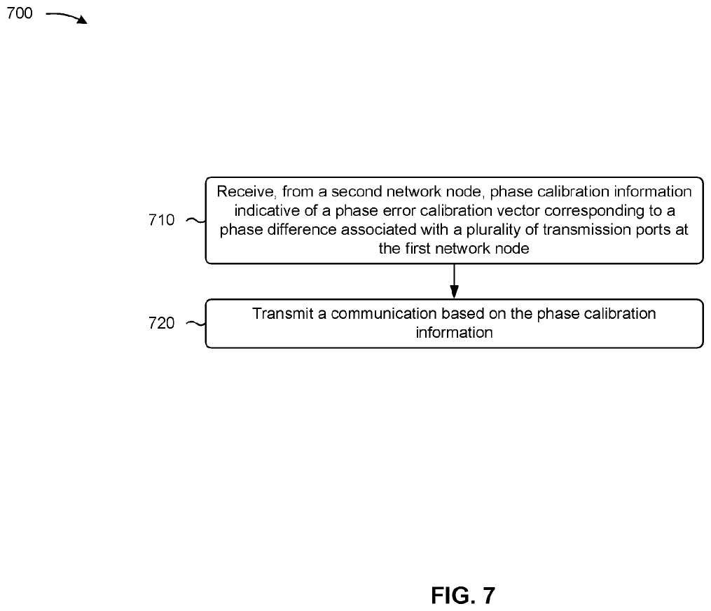

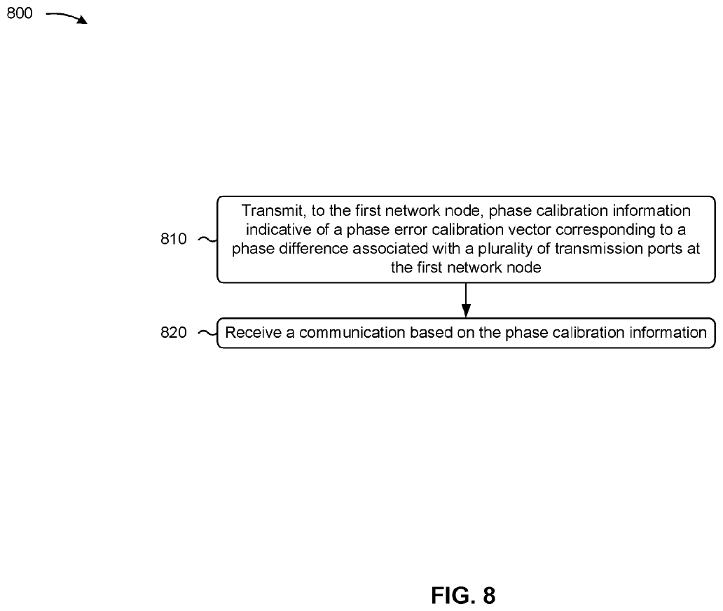

The controller/processor 240 of the network node 110, the controller/processor 280 of the UE 120, and/or any other component(s) of FIG. 2 may perform one or more techniques associated with transmission port calibration, as described in more detail elsewhere herein. For example, the controller/processor 240 of the network node 110, the controller/processor 280 of the UE 120, and/or any other component(s) of FIG. 2 may perform or direct operations of, for example, process 700 of FIG. 7, process 800 of FIG. 8, and/or other processes as described herein. The memory 242 and the memory 282 may store data and program codes for the network node 110 and the UE 120, respectively. In some examples, the memory 242 and/or the memory 282 may include a non-transitory computer-readable medium storing one or more instructions (e.g., code and/or program code) for wireless communication. For example, the one or more instructions, when executed (e.g., directly, or after compiling, converting, and/or interpreting) by one or more processors of the network node 110 and/or the UE 120, may cause the one or more processors, the UE 120, and/or the network node 110 to perform or direct operations of, for example, process 700 of FIG. 7, process 800 of FIG. 8, and/or other processes as described herein. In some examples, executing instructions may include running the instructions, converting the instructions, compiling the instructions, and/or interpreting the instructions, among other examples.

In some aspects, a first network node (e.g., the UE 120 or the network node 110) includes means for receiving, from a second network node, phase calibration information indicative of a phase error calibration vector corresponding to a phase difference associated with a plurality of transmission ports at the first network node; and/or means for transmitting a communication based on the phase calibration information.

In some aspects, a second network node (e.g., the UE 120 or the network node 110) includes means for transmitting, to a first network node, phase calibration information indicative of a phase error calibration vector corresponding to a phase difference associated with a plurality of transmission ports at the first network node; and/or means for receiving a communication based on the phase calibration information. In some aspects, means for the first network node and/or the second network node to perform operations described herein may include, for example, one or more of communication manager 140, controller/processor 280, memory 282, transmit processor 264, TX MIMO processor 266, antenna 252, modem 254, MIMO detector 256, receive processor 258, communication manager 150, transmit processor 220, TX MIMO processor 230, modem 232, antenna 234, MIMO detector 236, receive processor 238, controller/processor 240, memory 242, or scheduler 246.

While blocks in FIG. 2 are illustrated as distinct components, the functions described above with respect to the blocks may be implemented in a single hardware, software, or combination component or in various combinations of components. For example, the functions described with respect to the transmit processor 264, the receive processor 258, and/or the TX MIMO processor 266 may be performed by or under the control of the controller/processor 280.

As indicated above, FIG. 2 is provided as an example. Other examples may differ from what is described with regard to FIG. 2.

Deployment of communication systems, such as 5G NR systems, may be arranged in multiple manners with various components or constituent parts. In a 5G NR system, or network, a network node, a network entity, a mobility element of a network, a RAN node, a core network node, a network element, a base station, or a network equipment may be implemented in an aggregated or disaggregated architecture. For example, a base station (such as a Node B (NB), an evolved NB (eNB), an NR BS, a 5G NB, an access point (AP), a TRP, or a cell, among other examples), or one or more units (or one or more components) performing base station functionality, may be implemented as an aggregated base station (also known as a standalone base station or a monolithic base station) or a disaggregated base station. “Network entity” or “network node” may refer to a disaggregated base station, or to one or more units of a disaggregated base station (such as one or more CUs, one or more DUs, one or more RUs, or a combination thereof).

An aggregated base station (e.g., an aggregated network node) may be configured to utilize a radio protocol stack that is physically or logically integrated within a single RAN node (e.g., within a single device or unit). A disaggregated base station (e.g., a disaggregated network node) may be configured to utilize a protocol stack that is physically or logically distributed among two or more units (such as one or more CUs, one or more DUs, or one or more RUs). In some examples, a CU may be implemented within a network node, and one or more DUs may be co-located with the CU, or alternatively, may be geographically or virtually distributed throughout one or multiple other network nodes. The DUs may be implemented to communicate with one or more RUs. Each of the CU, DU and RU also can be implemented as virtual units, such as a virtual central unit (VCU), a virtual distributed unit (VDU), or a virtual radio unit (VRU), among other examples.

Base station-type operation or network design may consider aggregation characteristics of base station functionality. For example, disaggregated base stations may be utilized in an IAB network, an open radio access network (O-RAN (such as the network configuration sponsored by the O-RAN Alliance)), or a virtualized radio access network (vRAN, also known as a cloud radio access network (C-RAN)) to facilitate scaling of communication systems by separating base station functionality into one or more units that can be individually deployed. A disaggregated base station may include functionality implemented across two or more units at various physical locations, as well as functionality implemented for at least one unit virtually, which can enable flexibility in network design. The various units of the disaggregated base station can be configured for wired or wireless communication with at least one other unit of the disaggregated base station.

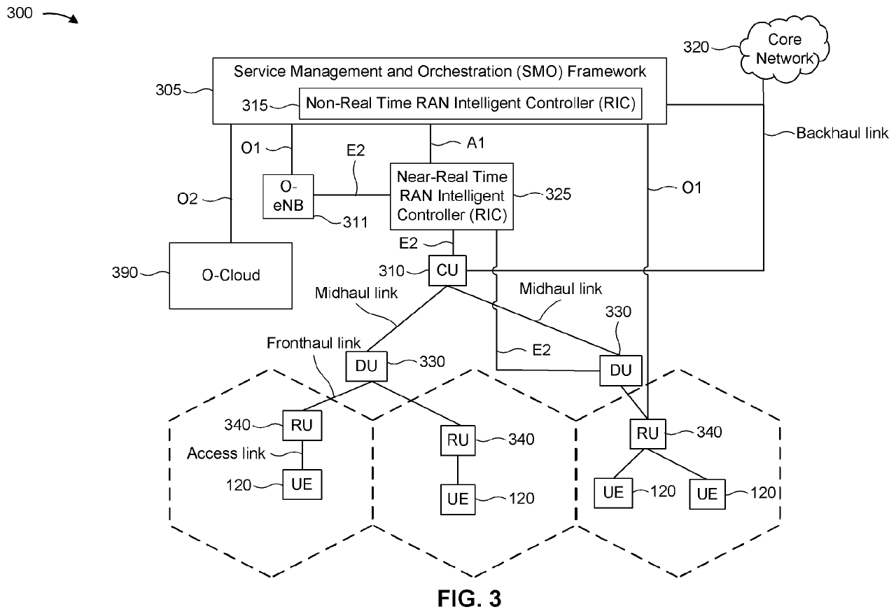

FIG. 3 is a diagram illustrating an example disaggregated base station architecture 300, in accordance with the present disclosure. The disaggregated base station architecture 300 may include a CU 310 that can communicate directly with a core network 320 via a backhaul link, or indirectly with the core network 320 through one or more disaggregated control units (such as a Near-RT RIC 325 via an E2 link, or a Non-RT RIC 315 associated with a Service Management and Orchestration (SMO) Framework 305, or both). A CU 310 may communicate with one or more DUs 330 via respective midhaul links, such as through F1 interfaces. Each of the DUs 330 may communicate with one or more RUs 340 via respective fronthaul links. Each of the RUs 340 may communicate with one or more UEs 120 via respective RF access links. In some implementations, a UE 120 may be simultaneously served by multiple RUs 340.

Each of the units, including the CUs 310, the DUs 330, the RUs 340, as well as the Near-RT RICs 325, the Non-RT RICs 315, and the SMO Framework 305, may include one or more interfaces or be coupled with one or more interfaces configured to receive or transmit signals, data, or information (collectively, signals) via a wired or wireless transmission medium. Each of the units, or an associated processor or controller providing instructions to one or multiple communication interfaces of the respective unit, can be configured to communicate with one or more of the other units via the transmission medium. In some examples, each of the units can include a wired interface, configured to receive or transmit signals over a wired transmission medium to one or more of the other units, and a wireless interface, which may include a receiver, a transmitter or transceiver (such as an RF transceiver), configured to receive or transmit signals, or both, over a wireless transmission medium to one or more of the other units.

In some aspects, the CU 310 may host one or more higher layer control functions. Such control functions can include radio resource control (RRC) functions, packet data convergence protocol (PDCP) functions, or service data adaptation protocol (SDAP) functions, among other examples. Each control function can be implemented with an interface configured to communicate signals with other control functions hosted by the CU 310. The CU 310 may be configured to handle user plane functionality (for example, Central Unit-User Plane (CU-UP) functionality), control plane functionality (for example, Central Unit-Control Plane (CU-CP) functionality), or a combination thereof. In some implementations, the CU 310 can be logically split into one or more CU-UP units and one or more CU-CP units. A CU-UP unit can communicate bidirectionally with a CU-CP unit via an interface, such as the E1 interface when implemented in an O-RAN configuration. The CU 310 can be implemented to communicate with a DU 330, as necessary, for network control and signaling.

Each DU 330 may correspond to a logical unit that includes one or more base station functions to control the operation of one or more RUs 340. In some aspects, the DU 330 may host one or more of a radio link control (RLC) layer, a MAC layer, and one or more high physical (PHY) layers depending, at least in part, on a functional split, such as a functional split defined by the 3GPP. In some aspects, the one or more high PHY layers may be implemented by one or more modules for forward error correction (FEC) encoding and decoding, scrambling, and modulation and demodulation, among other examples. In some aspects, the DU 330 may further host one or more low PHY layers, such as implemented by one or more modules for a fast Fourier transform (FFT), an inverse FFT (iFFT), digital beamforming, or physical random access channel (PRACH) extraction and filtering, among other examples. Each layer (which also may be referred to as a module) can be implemented with an interface configured to communicate signals with other layers (and modules) hosted by the DU 330, or with the control functions hosted by the CU 310.

Each RU 340 may implement lower-layer functionality. In some deployments, an RU 340, controlled by a DU 330, may correspond to a logical node that hosts RF processing functions or low-PHY layer functions, such as performing an FFT, performing an iFFT, digital beamforming, or PRACH extraction and filtering, among other examples, based on a functional split (for example, a functional split defined by the 3GPP), such as a lower layer functional split. In such an architecture, each RU 340 can be operated to handle over the air (OTA) communication with one or more UEs 120. In some implementations, real-time and non-real-time aspects of control and user plane communication with the RU(s) 340 can be controlled by the corresponding DU 330. In some scenarios, this configuration can enable each DU 330 and the CU 310 to be implemented in a cloud-based RAN architecture, such as a vRAN architecture.

The SMO Framework 305 may be configured to support RAN deployment and provisioning of non-virtualized and virtualized network elements. For non-virtualized network elements, the SMO Framework 305 may be configured to support the deployment of dedicated physical resources for RAN coverage requirements, which may be managed via an operations and maintenance interface (such as an O1 interface). For virtualized network elements, the SMO Framework 305 may be configured to interact with a cloud computing platform (such as an open cloud (O-Cloud) platform 390) to perform network element life cycle management (such as to instantiate virtualized network elements) via a cloud computing platform interface (such as an O2 interface). Such virtualized network elements can include, but are not limited to, CUs 310, DUs 330, RUs 340, non-RT RICs 315, and Near-RT RICs 325. In some implementations, the SMO Framework 305 can communicate with a hardware aspect of a 4G RAN, such as an open eNB (O-eNB) 311, via an O1 interface. Additionally, in some implementations, the SMO Framework 305 can communicate directly with each of one or more RUs 340 via a respective O1 interface. The SMO Framework 305 also may include a Non-RT RIC 315 configured to support functionality of the SMO Framework 305.

The Non-RT RIC 315 may be configured to include a logical function that enables non-real-time control and optimization of RAN elements and resources, Artificial Intelligence/Machine Learning (AI/ML) workflows including model training and updates, or policy-based guidance of applications/features in the Near-RT RIC 325. The Non-RT RIC 315 may be coupled to or communicate with (such as via an A1 interface) the Near-RT RIC 325. The Near-RT RIC 325 may be configured to include a logical function that enables near-real-time control and optimization of RAN elements and resources via data collection and actions over an interface (such as via an E2 interface) connecting one or more CUs 310, one or more DUs 330, or both, as well as an O-eNB, with the Near-RT RIC 325.

In some implementations, to generate AI/ML models to be deployed in the Near-RT RIC 325, the Non-RT RIC 315 may receive parameters or external enrichment information from external servers. Such information may be utilized by the Near-RT RIC 325 and may be received at the SMO Framework 305 or the Non-RT RIC 315 from non-network data sources or from network functions. In some examples, the Non-RT RIC 315 or the Near-RT RIC 325 may be configured to tune RAN behavior or performance. For example, the Non-RT RIC 315 may monitor long-term trends and patterns for performance and employ AI/ML models to perform corrective actions through the SMO Framework 305 (such as reconfiguration via an O1 interface) or via creation of RAN management policies (such as A1 interface policies)

As indicated above, FIG. 3 is provided as an example. Other examples may differ from what is described with regard to FIG. 3.

A multi-antenna UE 120 and/or a set of antenna ports of the UE 120 may be classified into one of three groups depending on coherence of the antenna ports of the UE 120. A set of antenna ports (e.g., two antenna ports) are coherent if the relative phase among the set of antenna ports (e.g., between the two antenna ports) remains the same between the time of a SRS transmission from those antenna ports and a subsequent physical uplink shared channel (PUSCH) transmission from those antenna ports. When this is the case, the SRS can be used (e.g., by the UE 120 and/or a network node 110) to determine an uplink precoder for precoding the PUSCH transmission, since the relative phase of the antenna ports will be the same for the SRS transmission and the PUSCH transmission. In this case, precoding can span across the set of coherent antenna ports (sometimes referred to herein as coherent ports). If a set of antenna ports is not coherent (i.e., non-coherent), then such an uplink precoder determination becomes difficult, because the relative phase of the antenna ports will change from the SRS transmission to the PUSCH transmission.

For example, a set of antenna ports is considered non-coherent if the relative phase among the set of antenna ports is different for the SRS transmission and the PUSCH transmission. In this case, precoding does not span across the set of non-coherent antenna ports (sometimes referred to as non-coherent ports). Furthermore, a set of antenna ports is considered partially-coherent if a first subset of the set of antenna ports is coherent with one another and a second subset of the set of antenna ports is coherent with one another, but the first subset of antenna ports and the second subset of antenna ports are not coherent with one another. In this case, common precoding may be used within the subsets of coherent ports, but not across the subsets of non-coherent ports. However, certain techniques can be applied to synthesize a virtual antenna port (sometimes referred to herein as a virtual port) from antenna ports that lack coherence (e.g., so that common precoding can be used on the virtual port and applied to the non-coherent antenna ports).

For example, a set of non-coherent antenna ports (e.g., shown as two non-coherent antenna ports) can be combined into a single virtual port using precoding (e.g., uplink precoding) and cyclic delay diversity. The precoder may be determined by the UE 120 and/or signaled by a network node 110. “Cyclic delay diversity” (CDD) may refer to a technique where a delay (e.g., a cyclic delay) is introduced on one of the non-coherent ports and not on the other non-coherent port. The delay may be measured in samples (e.g., 5 samples, 10 samples, and/or the like), fractions of samples, and/or the like. For example, a first non-coherent port may transmit a first stream of samples, and the second non-coherent port may transmit a second stream of samples (e.g., which may be the same stream) with a slight cyclic delay (e.g., a delay of 5 samples, 10 samples, and/or the like). For example, for a cyclic delay of 5 samples, where 16 samples are transmitted per symbol, the first non-coherent port may transmit the 16 samples with a first sample transmitted first (e.g., [s1, s2, s3, s4, . . . , s16]), and the second non-coherent port may transmit the 16 samples with the first sample transmitted sixth (e.g., with a delay of five samples) (e.g., [s12, s13, s14, s15, s16, s1, s2, s3, . . . , s11]).

Additionally, or alternatively, a set of partially-coherent antenna ports (sometimes referred to herein as partially-coherent ports) can be combined into a single virtual port using precoding (e.g., uplink precoding) and cyclic delay diversity, in a similar manner as described above. As shown, a first subset of ports may be coherent with one another, and a second subset of ports may be coherent with one another, but the two subsets may not be coherent with one another. As further shown, precoding may be applied to the individual subsets to generate a first virtual port and a second virtual port that are not coherent with one another. Then, CDD may be applied to these two virtual ports (e.g., by transmitting communications from the virtual ports using CDD), thereby forming a single virtual port from the partially-coherent ports (e.g., using precoding and CDD).

When a UE 120 is configured with multiple SRS ports for a MIMO mode, the UE 120 may be required to split a transmission power equally across all antenna ports used for a PUSCH transmission using a power scaling factor. The power scaling factor may be equal to the number of antenna ports with non-zero PUSCH transmission power divided by the maximum number of SRS ports supported by the UE 120 in one SRS resource. In this case, the UE 120 may not be able to transmit with maximum transmission power because the UE 120 is required to split the transmission power equally across all antenna ports on which the UE is configured to transmit a PUSCH communication. For example, when the UE 120 uses precoding to transmit on a single port (e.g., port 0) of two configured ports (port 0 and port 1), the transmission power of the transmission on the single port (port 0) is scaled by a factor of ½ (one half).

In some cases, a network node 110 may need to instruct a UE 120 to transmit at maximum power, such as when the UE 120 is located near a cell edge or otherwise has poor link quality with the network node 110. However, different UEs 120 may have different capabilities regarding virtual port synthesis and which virtual ports of the UE 120 are capable of supporting a maximum transmission power. For example, the UE 120 may or may not be capable of synthesizing a virtual port that supports a maximum transmission power (e.g., of a power class of the UE 120) and/or may only be capable of supporting a maximum transmission power for a virtual port that is a combination of a specific set of actual antenna ports of the UE 120, depending on the hardware components of the UE 120, a number of transmission antennas of the UE 120, a number of transmission chains of the UE 120, a maximum transmission power supported by different power amplifiers and/or different combinations of power amplifiers of the UE 120, and/or the like.

In order for a network node 110 to instruct a UE 120 regarding a precoder (e.g., corresponding to a transmitted precoding matrix indicator (TPMI)) to be used to transmit at maximum power, the network node 110 needs to know which precoder(s) of the UE 120 are capable of supporting transmissions at the maximum power. However, the network node 110 may not have information regarding such capabilities of the UE 120, which may result in an instruction to transmit at maximum power using a precoder with which the UE 120 is not capable of transmitting at the maximum power. Some techniques and apparatuses described herein permit a UE 120 to signal capabilities regarding a total power scaling factor of the UE 120, precoders (e.g., TPMIs) that support a maximum transmission power for the UE 120, and/or the like. In this way, the network node 110 may configure and/or instruct the UE 120 to transmit at maximum transmission power using power scaling factors and/or precoders that supports the maximum transmission power.

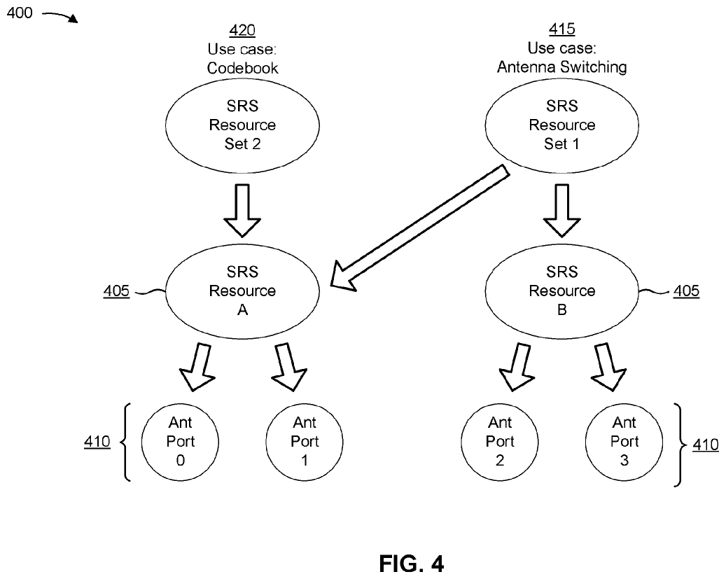

FIG. 4 is a diagram illustrating an example 400 of SRS resource sets, in accordance with various aspects of the present disclosure.

A network node 110 may configure a UE 120 with one or more SRS resource sets to allocate resources for SRS transmissions by the UE 120. For example, a configuration for SRS resource sets may be indicated in an RRC message (e.g., an RRC configuration message, an RRC reconfiguration message, and/or the like). As shown by reference number 405, an SRS resource set may include one or more resources (e.g., shown as SRS resources), which may include time resources and/or frequency resources (e.g., a slot, a symbol, a resource block, a periodicity for the time resources, and/or the like).

As shown by reference number 410, an SRS resource may include one or more antenna ports on which an SRS is to be transmitted (e.g., in a time-frequency resource). Thus, a configuration for an SRS resource set may indicate one or more time-frequency resources in which an SRS is to be transmitted, and may indicate one or more antenna ports on which the SRS is to be transmitted in those time-frequency resources. In some aspects, the configuration for an SRS resource set may indicate a use case (e.g., in an SRS-SetUse information element) for the SRS resource set. For example, an SRS resource set may have a use case of antenna switching, codebook, non-codebook, beam management, and/or the like.

An antenna switching SRS resource set may be used to indicate downlink channel state information (CSI) with reciprocity between an uplink and downlink channel. For example, when there is reciprocity between an uplink channel and a downlink channel, a network node 110 may use an antenna switching SRS (e.g., an SRS transmitted using a resource of an antenna switching SRS resource set) to acquire downlink CSI (e.g., to determine a downlink precoder to be used to communicate with the UE 120).

A codebook SRS resource set may be used to indicate uplink CSI when a network node 110 indicates an uplink precoder to the UE 120. For example, when the network node 110 is configured to indicate an uplink precoder to the UE 120 (e.g., using a precoder codebook), the network node 110 may use a codebook SRS (e.g., an SRS transmitted using a resource of a codebook SRS resource set) to acquire uplink CSI (e.g., to determine an uplink precoder to be indicated to the UE 120 and used by the UE 120 to communicate with the network node 110). In some aspects, virtual ports (e.g., a combination of two or more antenna ports) with a maximum transmission power may be supported at least for a codebook SRS.

A non-codebook SRS resource set may be used to indicate uplink CSI when the UE 120 selects an uplink precoder to be used by the UE 120. For example, when the UE 120 is configured to select an uplink precoder, the network node 110 may use a non-codebook SRS (e.g., an SRS transmitted using a resource of a non-codebook SRS resource set) to acquire uplink CSI. In this case, the non-codebook SRS may be precoded using a precoder selected by the UE 120 (e.g., which may be indicated to the network node 110).

A beam management SRS resource set may be used for indicating CSI for millimeter wave communications.

As shown in FIG. 4, in some aspects, different SRS resource sets indicated to the UE 120 (e.g., having different use cases) may overlap (e.g., in time, in frequency, and/or the like, such as in the same slot). For example, as shown by reference number 415, a first SRS resource set (e.g., shown as SRS Resource Set 1) is shown as having an antenna switching use case. As shown, this example antenna switching SRS resource set includes a first SRS resource (shown as SRS Resource A) and a second SRS resource (shown as SRS Resource B). Thus, antenna switching SRS may be transmitted in SRS Resource A (e.g., a first time-frequency resource) using antenna port 0 and antenna port 1, and may be transmitted in SRS Resource B (e.g., a second time-frequency resource) using antenna port 2 and antenna port 3.

As shown by reference number 420, a second SRS resource set (e.g., shown as SRS Resource Set 2) may be a codebook use case. As shown, this example codebook SRS resource set includes only the first SRS resource (shown as SRS Resource A). Thus, codebook SRS may be transmitted in SRS Resource A (e.g., the first time-frequency resource) using antenna port 0 and antenna port 1. In this case, the UE 120 may not transmit code book SRS in SRS Resource B (e.g., the second time-frequency resource) using antenna port 2 and antenna port 3.

When a UE 120 is configured with multiple SRS ports for a MIMO mode, the UE 120 may be required to split a transmission power equally across all antenna ports used for a PUSCH transmission using a power scaling factor. In this case, the UE 120 may not be able to transmit with maximum transmission power using a virtual port that is a combination of multiple non-coherent ports and/or multiple partially-coherent ports, because the UE 120 is required to split the transmission power equally across all antenna ports on which the UE transmits a PUSCH communication with non-zero transmission power. Some techniques and apparatuses described herein permit the UE 120 to transmit at a total transmission power comprising a summation of a plurality of power scaling factors associated with a plurality of PAs (e.g., configured by an SRS configuration).

As indicated above, FIG. 4 is provided as an example. Other examples may differ from what is described with regard to FIG. 4.

In some cases, a first network node (e.g., a UE) can transmit communications to a second network node (e.g., a base station). In some cases, the transmissions can be referred to as uplink transmissions. For example, the second network node can schedule or configure uplink transmissions for the first network node on an uplink. In some cases, the second network node can configure the first network node to perform a codebook-based PUSCH transmission, which can be a PUSCH transmission that is configured to be performed in an SRS resource set with a usage of ‘codebook’ configured for the first network node. The SRS resource set can include N SRS resources (e.g., where N=1, 2, 3, or 4), and the second network node can configure the quantity of SRS ports and spatial relation information for each of the SRS resources on a per-SRS resource basis.

The spatial relation information for an SRS resource can indicate a reference signal index (e.g., a synchronization signal block (SSB), a CSI reference signal (CSI-RS), or another SRS resource) for transmission of the SRS resource (and thus, the associated PUSCH transmission). The first network node can use the same spatial domain transmission filter as the reference signal indicated in the spatial relation information (spatialRelationInfo), which can effectively be an uplink beam for the PUSCH transmission.

The second network node can indicate, to the first network node, an SRS resource for a PUSCH transmission by indicating the SRS resource in an SRS resource indicator (SRI) field in a downlink communication (e.g., a DCI communication with a format 0_1, which can be an uplink scheduling DCI) that schedules the PUSCH transmission. The first network node can use the same spatial domain transmission filter for the PUSCH transmission as the indicated SRS resource, and can use the quantity of SRS ports of the indicated SRS resource as the quantity of antenna ports for the PUSCH transmission.

In some cases, the downlink communication can further indicate a TPMI and a quantity of layers for the PUSCH transmission. For example, if the downlink communication is a DCI communication, the DCI communication can include a Precoding Information and Number of Layers field that indicates the TPMI and the quantity of layers. The Precoding Information and Number of Layers field can include a codepoint (e.g., a plurality of bits indicating or representing a particular value) that identifies an index associated with a row or column in a table or another type of data structure. The row or column can indicate the quantity of layers and the TPMI that are associated with the index.

In some cases, the size of the field can be based at least in part on the quantity of antenna ports indicated for the SRS resource, a Codebooksubset field, a Maxrank field, and/or a TransformPrecoder field. The quantity of antenna ports can be used to identify a quantity of rows for an associated TPMI matrix. The Codebooksubset field can indicate whether the antenna ports are fully coherent, partially coherent, noncoherent, or a combination thereof in the case that some antenna ports are pair-wise coherent but not full coherent (e.g., Pair 1 of two antenna ports are coherent, Pair 2 of another two antenna ports are coherent, but Pair 1 and Pair 2 are noncoherent). For example, the Codebooksubset field can indicate that the antenna ports are fullyAndPartialAndNonCoherent, or partialAndNonCoherent, or noncoherent. In some cases, all TPMI indices that can be indicated by the second network node can be used for fully AndPartialAndNonCoherent antenna ports, a subset of the TPMI indices can be used for partialAndNonCoherent antenna ports, and another subset of the TPMI indices can be used for noncoherent antenna ports. The Maxrank field can indicate a maximum quantity of layers for the PUSCH transmission. The TransformPrecoder field can indicate whether DFT-s-OFDM or CP-OFDM is enabled based at least in part on whether the TransformPrecoder field is enabled.

In some cases, a second network node can configure a first network node to transmit a plurality of repetitions of the same PUSCH transmission (e.g., a plurality of repetitions of the same PUSCH transport block), where each repetition can be directed to a TRP among a plurality of TRPs in a multi-TRP configuration, an antenna panel among a plurality of antenna panels in a multi-panel configuration, or an antenna among a plurality of antennas in a multi-antenna configuration. Thus, if an access link between the first network node and a TRP (or antenna panel or antenna) (which may be, include, or be included in, a second network node) is blocked such that a repetition transmitted to the TRP is not received, another repetition transmitted to another TRP can be received such that the PUSCH transmission can be decoded.

In some cases, a first network node can receive, from a second network node, a downlink communication that includes one or more codepoints indicating a number of TPMI indices and/or an SRI codepoint indicating one or more SRS resources. The first network node can identify, based at least in part on the one or more codepoints, one or more TPMI indices, of the plurality of TPMI indices, for one or more repetitions of a codebook-based PUSCH transmission and/or can identify, based at least in part on the SRI codepoint, one or more SRS resources for the one or more repetitions.

As indicated above, FIG. 4 is provided as an example. Other examples may differ from what is described with regard to FIG. 4.

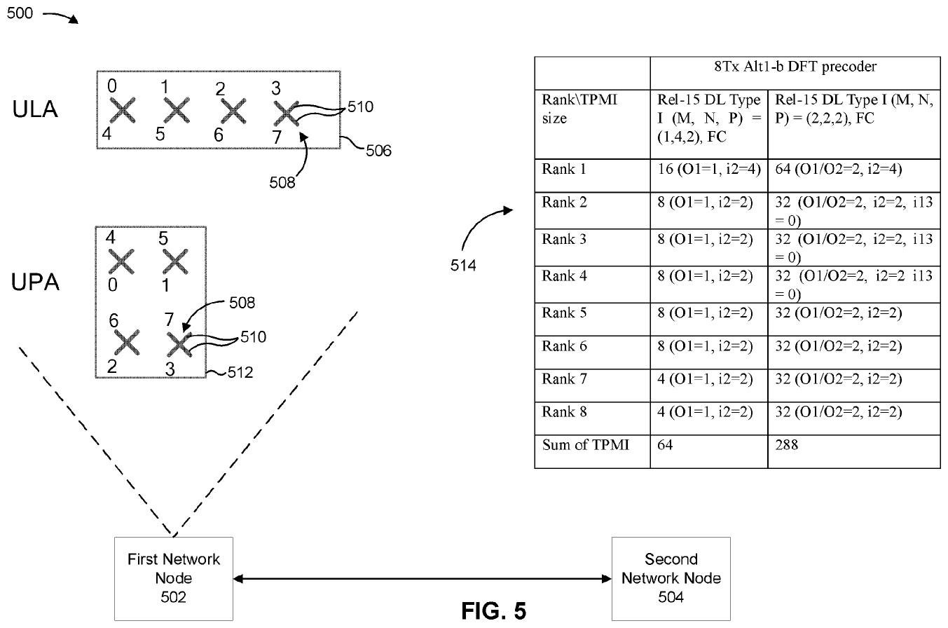

FIG. 5 is a diagram illustrating an example 500 associated with codebook-based PUSCH communications, in accordance with the present disclosure. As shown, a first network node 502 and a second network node 504 may communicate with one another. In some cases, the first network node 502 may be a UE and the second network node 504 may be a base station. In some cases, the first network node 502 and/or the second network node 504 may be, be similar to, include, or be included in, the UE 120 and/or the network node 110 depicted in FIGS. 1 and 2, and/or one or more components of the disaggregated base station architecture 300 depicted in FIG. 3.

As shown, the first network node 502 can be configured with eight transmission ports (e.g., eight transmission antenna elements and/or eight transmission chains and/or power amplifiers), and may be referred to as an 8 Tx network node. In some cases, for example, the first network node 502 can transmit Rank 1 PUSCH, Rank 2 PUSCH, Rank 3 PUSCH, Rank 4 PUSCH, Rank 5 PUSCH, Rank 6 PUSCH, Rank 7 PUSCH, and/or Rank 8 PUSCH using different combinations of the antenna elements. For example, as shown, the network node 502 can be configured with a uniform linear array (ULA) 506 having four antennas 508. Each antenna 508 can include one or more antenna elements 510 for radiating and/or receiving RF signals.

For example, a single antenna 508 can include a first antenna element 510 cross-polarized with a second antenna element 510 that can be used to independently transmit or receive cross-polarized signals. The antenna elements 508 can include patch antennas, dipole antennas, or other types of antennas arranged in a linear pattern. As shown, the first network node 502 can include a uniform planar array (UPA) 512 in which the antennas 508 are arranged in a two-dimensional pattern.

In some cases, the second network node 504 can schedule or configure the first network node 502 to transmit one or more PUSCH transmissions. In some cases, the PUSCH transmission can be a codebook-based PUSCH transmission (e.g., where an SRS resource set is configured for the PUSCH transmission with usage of ‘codebook’). For example, the second network node 504 can transmit a downlink communication to the first network node 502. The downlink communication can include one or more codepoints indicating a plurality of TPMI indices for the PUSCH transmission and/or can include an SRI codepoint indicating one or more SRS resources for the PUSCH transmission.

In some aspects, the second network node 504 can schedule or configure PUSCH transmissions for the first network node 502 using a configured uplink grant. In this case, the second network node 504 can transmit an RRC communication that configures recurring or periodic resources that the first network node 502 can use for the PUSCH transmissions (which can be referred to as Type 1 configured grant PUSCH (CG-PUSCH) scheduling), or can transmit an RRC communication that configures the CG-PUSCH and activates the CG-PUSCH via a DCI communication (which can be referred to as Type 2 CG-PUSCH). If the downlink communication is a Type 1 CG-PUSCH RRC communication, the one or more codepoints can be included in a precodingAndNumberOfLayers field in the RRC communication, and the SRI codepoint can be included in an srs-Resourceindicator field in the RRC communication.

In some aspects, the second network node 504 can schedule or configure PUSCH transmissions for the first network node 502 using dynamic scheduling. In this case, the second network node 504 can transmit DCI communications (e.g., format 0_1 DCI communications) to the first network node 502 to schedule or configure resources for PUSCH transmissions. If the downlink communication is a DCI communication, the one or more codepoints can be included in a Precoding Information and Number of Layers field or another field that is used to indicate TPMI indices and a quantity of layers for the PUSCH transmission, and/or the SRI codepoint can be included in an SRI field.

In some cases, a candidate discrete Fourier transform (DFT)-based coherent precoder 514 for 8 Tx uplink communications can indicate one or more TPMI indices. For example, the precoder 514 can indicate a codepoint and an associated rank indicator (RI) and/or TPMI size. In some aspects, a DCI communication may include the precoder 514. As shown, for example, the precoder 514 can include a first column of indicating the RI and/or TPMI size (RI/TPMI size). The RI/TPMI size may correspond to an associated codepoint value indicated in a Precoding Information and Number of Layers field. The precoder 514 can include a mapping that can indicate the quantity of layers, the quantity of TPMI indices, and the TPMI indices for an index value (codepoint value). The mapping in each row can specify an order of the TPMI indices indicated in the row. In this case, each combination of TPMI indices can be included in the table a plurality of times such that different orders of the same combination of TPMI indices are included. In some cases, the 8 Tx coherent precoder can be based on a DFT matrix. In this way, one example of an 8 Tx precoder can be similar to a downlink type-18 Tx codebook, which is based on a DFT codebook with oversampling factor and a co-phasing factor φ.

In systems that employ antenna arrays, there can be two kinds of mismatches among antennas. A first kind of mismatch can refer to mismatches due to the physical antenna system/structure. For example, the mismatches can include effects of mutual coupling, tower effects, imperfect knowledge of the antenna element locations, and/or amplitude and phase mismatches due to antenna cabling, among other examples. A second kind of mismatch can refer to mismatches due to hardware elements in each antenna TX/RX chain. The second kind of mismatch can include effects related to mismatches associated with, for example, analog filters, I and Q imbalances, phase and gain mismatch of low noise amplifiers (LNAs) and/or power amplifiers (PAs) on the Tx/Rx chains, and/or different nonlinearity effects, among other examples.

In some cases, for example, phase error among different antenna ports can result in the mismatch between the DFT precoder and un-calibrated UL channels. As a result, the throughput of the UL transmission can degrade without Tx phase calibration, making codebook-based PUSCH difficult to perform.

For example, in a simplified system model with N UE Tx, 1 gNB Rx, and a single tap channel, in which the N Tx port sounding are orthogonal via different combs and/or cyclic shifts, the SRS received at tone k for UE Tx port n can be represented as the following:

$${y}_{n} ( k ) = {e}^{j {φ}_{n}} h ( k ) {e}^{j \frac{2 π}{λ} nds i n θ} + ϖ ( k ) ,$$

On is the Tx phase error to be calibrated on n-th Tx, n=1, . . . , N, h(k) is the channel on tone k, d is the distance between Tx antennas, θ is angle of Tx, and ω̅(k) is the noise on tone k. In the example, the SRS ports and PUSCH ports are coherent. An 8 Tx phase error model indicates that for a ULA antenna structure and the DFT precoder 514, the phase error θ~U [−π, π] results in 12.1% throughput loss at the cell edge, 12.7% throughput loss in the cell center, and 14.3% average throughput loss. For a UPA antenna structure, the phase error θ~U [−π, π] results in 13.2% throughput loss at the cell edge, 16% throughput loss in the cell center, and 13.2% average throughput loss. Thus, without phase error calibration, degradation of uplink throughput in codebook based PUSCH communications can occur.

Some aspects of the techniques and apparatuses described herein may provide a phase calibration procedure for codebook based PUSCH communications. For example, in some aspects, the second network node 504 may indicate a configuration of SRS resources for uplink phase error calibration. The first network node 502 may transmit SRSs on a plurality of uplink transmission ports (e.g., on all uplink transmission ports). The second network node 504 may estimate the phase difference among the Tx ports of the first network node 502 and may generate a phase error calibration vector based on the estimated phase difference. The estimation may be performed using any number of different phase estimation techniques including, for example, application of a least squares estimator, machine learning models, and/or any other number of techniques.

The second network node 504 may transmit, to the first network node 502, phase calibration information indicative of a phase error calibration vector corresponding to a phase difference associated with a plurality of transmission ports at the first network node 502. The first network node 502 may use the calibration vector to adjust transmission phase of one or more of the transmission ports, and may transmit a communication to the second network node 504 using the adjusted phase. For example, in some aspects, the first network node 502 may transmit a PUSCH communication based on the phase calibration information. In some aspects, the first network node 502 may transmit an SRS used for codebook-based PUSCH. The second network node 504 may transmit, based on the SRS, an uplink resource grant for PUSCH communications. The uplink resource grant may include TPMI and/or RI information. The first network node 502 may use the same phase adjustment to transmit a PUSCH communication based on the uplink grant. In this way, aspects of the techniques and apparatuses described herein may facilitate phase error calibration of uplink transmission ports, thereby facilitating codebook-based PUSCH communication while mitigating degradation of the channel due to antenna mismatches.

As indicated above, FIG. 5 is provided as an example. Other examples may differ from what is described with regard to FIG. 5.

FIG. 6 is a flow diagram illustrating an example 600 of codebook-based uplink communication, in accordance with the present disclosure. As shown, a first network node 602 and a second network node 604 may communicate with one another. In some aspects, the first network node 602 and/or the second network node 604 may be, be similar to, include, or be included in, the first network node 502 and the second network node 504, respectively, depicted in FIG. 5, the UE 120 depicted in FIGS. 1-3, the network node 110 depicted in FIGS. 1 and 2, and/or one or more components of the disaggregated base station architecture 300 depicted in FIG. 3.

As shown by reference number 606, the second network node 604 may transmit, and the first network node 602 may receive, calibration configuration information. The calibration configuration information may be indicative of a set of SRS resources for phase error calibration. In some aspects, the set of SRS resources may include at least one of periodic SRS resources or semi-persistent SRS resources. In some aspects, the set of SRS resources may correspond to a bandwidth part (BWP). In some aspects, the set of SRS resources may include dedicated resources for transmission phase estimation. In some aspects, the set of SRS resources may be configured for downlink CSI acquisition. The set of SRS resources may be configured for codebook-based PUSCH communication.

As shown by reference number 608, the first network node 602 may transmit, and the second network node 604 may receive a plurality of SRSs. In some aspects, the plurality of SRSs may be transmitted based on the calibration configuration information. Each SRS of the plurality of SRSs may correspond to a respective transmission port of a plurality of transmission ports of the first network node 602.

As shown by reference number 610, the second network node 604 may generate a phase error calibration vector. For example, the second network node 604 may estimate a phase difference associated with the plurality of transmission ports at the first network node 602 and generate the phase error calibration vector based on the estimated phase difference. For example, if the first network node 602 has 4 transmission ports, the phase calibration vector may be given by [φ₁ φ₂ φ₃ φ₄]^{T}. In some aspects, the second network node 604 may define a reference Tx, in which case there may be no need to change the phase for the reference Tx, and the calibration vector may be given by [0 φ₂ φ₃ φ₄]^{T}.

As shown by reference number 612, the second network node 604 may transmit, and the first network node 602 may receive, phase calibration information. In some aspects, the phase calibration information may be transmitted using a medium access control control element (MAC CE) via a PDSCH. In some aspects, the phase calibration information may be transmitted using a plurality of periodic communications. A first periodic communication of the plurality of periodic communications may include first phase calibration information of the phase calibration information and a second periodic communication of the plurality of periodic communications may include second phase calibration information of the phase calibration information. In some aspects, the phase calibration information may be transmitted using an aperiodic communication. In some aspects, the second network node 604 may transmit, and the first network node 602 may receive, the phase calibration information based on a change in an estimated phase error satisfying a phase error change threshold.

The phase error calibration information may be indicative of the phase error calibration vector. The phase error calibration vector may include a plurality of elements, each of the plurality of elements corresponding to a respective transmission port of the plurality of transmission ports. In some aspects, each element may be quantized into a quantity of bits. The first network node 602 may obtain the quantity of bits based on at least one of an indication communication or information stored in a memory of the first network node (e.g., information specified by a wireless communication standard).

In some aspects, the second network node 604 may transmit, and the first network node 602 may receive, the phase calibration information by transmitting and receiving, respectively, a phase calibration report. The phase calibration report may be based on a report configuration. In some aspects, a parameter associated with the report configuration may be based on at least one of a minimum phase value, a maximum phase value, a fixed quantity of bits, or a one-bit quantization for a sign of a transmission phase. In some aspects, the parameter may include at least one of a range or a granularity.

In some aspects, the second network node 604 may transmit, and the first network node 602 may receive, the phase calibration information by transmitting and receiving, respectively, receiving a first phase calibration report indicative of the phase error calibration vector and a second phase calibration report indicative of a set of differential values associated with the phase error calibration vector and an additional phase error calibration vector. For example, the second phase calibration report may report a differential phase calibration vector, [Δφ₁ Δφ₂ Δφ₃ Δφ₄]^{T}.

As shown by reference number 614, the first network node 602 may transmit, and the second network node 604 may receive, a communication. The communication may be based on the phase calibration information. In some aspects, the communication may include a PUSCH communication. In some aspects, the communication may include an SRS. The SRS may be based on the phase error calibration vector and may correspond to a codebook-based PUSCH operation. For example, in some aspects, the SRS may be used by the second network node 604 to determine a TPMI and RI for a PUSCH communication. The second network node 604 may transmit, and the first network node 602 may receive, an uplink resource grant for transmitting the PUSCH communication, where the uplink resource grant indicates at least one of a TPMI or an RI. Based on the uplink grant, the first network node 602 may transmit, and the second network node 604 may receive, a PUSCH communication based on the phase error calibration vector.

As indicated above, FIG. 6 is provided as an example. Other examples may differ from what is described with regard to FIG. 6.

FIG. 7 is a diagram illustrating an example process 700 performed, for example, by a first network node, in accordance with the present disclosure. Example process 700 is an example where a first network node (e.g., the first network node 602) performs operations associated with transmission port calibration.

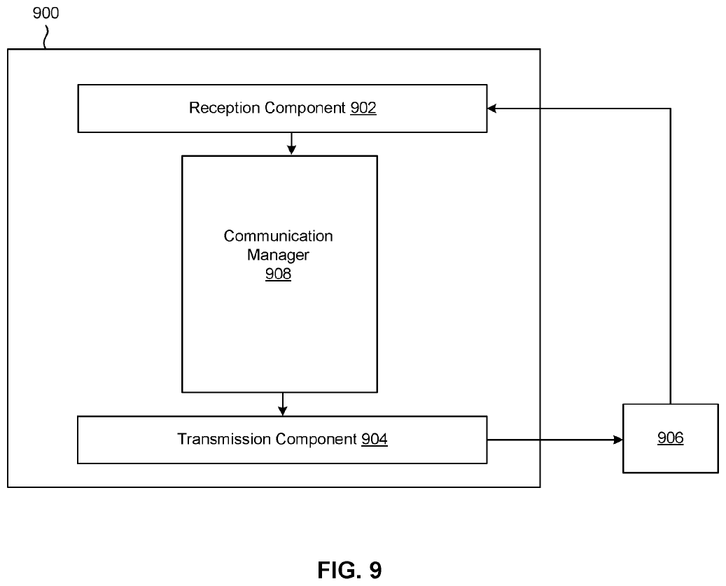

As shown in FIG. 7, in some aspects, process 700 may include receiving, from a second network node, phase calibration information indicative of a phase error calibration vector corresponding to a phase difference associated with a plurality of transmission ports at the first network node (block 710). For example, the first network node (e.g., using communication manager 908 and/or reception component 902, depicted in FIG. 9) may receive, from a second network node, phase calibration information indicative of a phase error calibration vector corresponding to a phase difference associated with a plurality of transmission ports at the first network node, as described above.

As further shown in FIG. 7, in some aspects, process 700 may include transmitting a communication based on the phase calibration information (block 720). For example, the first network node (e.g., using communication manager 908, reception component 902, and/or transmission component 904, depicted in FIG. 9) may transmit a communication based on the phase calibration information, as described above.

Process 700 may include additional aspects, such as any single aspect or any combination of aspects described below and/or in connection with one or more other processes described elsewhere herein.

In a first aspect, process 700 includes receiving, from the second network node, calibration configuration information indicative of a set of SRS resources for phase error calibration, and transmitting, based on the calibration configuration information, a plurality of SRSs, each SRSs of the plurality of SRSs corresponding to a respective transmission port of the plurality of transmission ports. In a second aspect, alone or in combination with the first aspect, the set of SRS resources comprises at least one of periodic SRS resources or semi-persistent SRS resources. In a third aspect, alone or in combination with one or more of the first and second aspects, the set of SRS resources corresponds to a bandwidth part. In a fourth aspect, alone or in combination with one or more of the first through third aspects, the set of SRS resources comprises dedicated resources for transmission phase estimation. In a fifth aspect, alone or in combination with one or more of the first through fourth aspects, the set of SRS resources is configured for downlink channel state information acquisition.

In a sixth aspect, alone or in combination with one or more of the first through fifth aspects, the set of SRS resources is configured for codebook-based physical uplink shared channel communication. In a seventh aspect, alone or in combination with the sixth aspect, the communication comprises an SRS. In an eighth aspect, alone or in combination with the seventh aspect, the SRS is based on the phase error calibration vector and corresponds to a codebook-based PUSCH operation. In a ninth aspect, alone or in combination with the eighth aspect, process 700 includes transmitting a PUSCH communication based on the phase error calibration vector. In a tenth aspect, alone or in combination with the ninth aspect, process 700 includes receiving an uplink resource grant for transmitting the PUSCH communication, wherein the uplink resource grant indicates at least one of a transmitted precoding matrix indicator or a rank indicator.

In an eleventh aspect, alone or in combination with one or more of the first through tenth aspects, receiving the phase calibration information comprises receiving a MAC CE via a physical downlink shared channel. In a twelfth aspect, alone or in combination with one or more of the first through eleventh aspects, receiving the phase calibration information comprises receiving a plurality of periodic communications, wherein a first periodic communication of the plurality of periodic communications includes first phase calibration information of the phase calibration information and a second periodic communication of the plurality of periodic communications includes second phase calibration information of the phase calibration information. In a thirteenth aspect, alone or in combination with one or more of the first through twelfth aspects, receiving the phase calibration information comprises receiving an aperiodic communication. In a fourteenth aspect, alone or in combination with the thirteenth aspect, receiving the phase calibration information comprises receiving the phase calibration information based on a change in an estimated phase error satisfying a phase error change threshold.

In a fifteenth aspect, alone or in combination with one or more of the first through fourteenth aspects, the phase error calibration vector includes a plurality of elements, each of the plurality of elements corresponding to a respective transmission port of the plurality of transmission ports. In a sixteenth aspect, alone or in combination with the fifteenth aspect, each element is quantized into a quantity of bits, the method further comprising obtaining the quantity of bits based on at least one of an indication communication or information stored in a memory of the first network node. In a seventeenth aspect, alone or in combination with one or more of the fifteenth or sixteenth aspects, receiving the phase calibration information comprises receiving a phase calibration report, wherein the phase calibration report is based on a report configuration.

In an eighteenth aspect, alone or in combination with the seventeenth aspect, a parameter associated with the report configuration is based on at least one of a minimum phase value, a maximum phase value, a fixed quantity of bits, or a one-bit quantization for a sign of a transmission phase. In a nineteenth aspect, alone or in combination with the eighteenth aspect, the parameter comprises at least one of a range or a granularity. In a twentieth aspect, alone or in combination with one or more of the fifteenth through nineteenth aspects, receiving the phase calibration information comprises receiving a first phase calibration report indicative of the phase error calibration vector, and receiving a second phase calibration report indicative of a set of differential values associated with the phase error calibration vector and an additional phase error calibration vector.

In a twenty-first aspect, alone or in combination with one or more of the first through twentieth aspects, the communication comprises a PUSCH communication.

Although FIG. 7 shows example blocks of process 700, in some aspects, process 700 may include additional blocks, fewer blocks, different blocks, or differently arranged blocks than those depicted in FIG. 7. Additionally, or alternatively, two or more of the blocks of process 700 may be performed in parallel.

FIG. 8 is a diagram illustrating an example process 800 performed, for example, by a second network node, in accordance with the present disclosure. Example process 800 is an example where a second network node (e.g., the second network node 604) performs operations associated with transmission port calibration.

As shown in FIG. 8, in some aspects, process 800 may include transmitting, to a first network node, phase calibration information indicative of a phase error calibration vector corresponding to a phase difference associated with a plurality of transmission ports at the first network node (block 810). For example, the second network node (e.g., using communication manager 908 and/or transmission component 904, depicted in FIG. 9) may transmit, to the first network node, phase calibration information indicative of a phase error calibration vector corresponding to a phase difference associated with a plurality of transmission ports at the first network node, as described above.

As further shown in FIG. 8, in some aspects, process 800 may include receiving a communication based on the phase calibration information (block 820). For example, the second network node (e.g., using communication manager 908 and/or reception component 902, depicted in FIG. 9) may receive a communication based on the phase calibration information, as described above.

Process 800 may include additional aspects, such as any single aspect or any combination of aspects described below and/or in connection with one or more other processes described elsewhere herein.

In a first aspect, process 800 includes transmitting, to the first network node, calibration configuration information indicative of a set of SRS resources for phase error calibration, and receiving, based on the calibration configuration information, at least one SRS corresponding to a respective transmission port of the plurality of transmission ports. In a second aspect, alone or in combination with the first aspect, the set of SRS resources comprises at least one of periodic SRS resources or semi-persistent SRS resources. In a third aspect, alone or in combination with one or more of the first and second aspects, the set of SRS resources corresponds to a bandwidth part. In a fourth aspect, alone or in combination with one or more of the first through third aspects, the set of SRS resources comprises dedicated resources for transmission phase estimation. In a fifth aspect, alone or in combination with one or more of the first through fourth aspects, the set of SRS resources is configured for downlink channel state information acquisition. In a sixth aspect, alone or in combination with one or more of the first through fifth aspects, the set of SRS resources is configured for codebook-based physical uplink shared channel communication.

In a seventh aspect, alone or in combination with one or more of the first through sixth aspects, the communication comprises an SRS. In an eighth aspect, alone or in combination with the seventh aspect, the SRS is based on the phase error calibration vector and corresponds to a codebook-based PUSCH operation. In a ninth aspect, alone or in combination with the eighth aspect, process 800 includes receiving a PUSCH communication based on the phase error calibration vector. In a tenth aspect, alone or in combination with the ninth aspect, process 800 includes transmitting an uplink resource grant for transmitting the PUSCH communication, wherein the uplink resource grant indicates at least one of a transmitted precoding matrix indicator or a rank indicator. In an eleventh aspect, alone or in combination with one or more of the first through tenth aspects, transmitting the phase calibration information comprises transmitting a MAC CE via a physical downlink shared channel.

In a twelfth aspect, alone or in combination with one or more of the first through eleventh aspects, transmitting the phase calibration information comprises transmitting a plurality of periodic communications, wherein a first periodic communication of the plurality of periodic communications includes first phase calibration information of the phase calibration information and a second periodic communication of the plurality of periodic communications includes second phase calibration information of the phase calibration information. In a thirteenth aspect, alone or in combination with one or more of the first through twelfth aspects, transmitting the phase calibration information comprises transmitting an aperiodic communication. In a fourteenth aspect, alone or in combination with the thirteenth aspect, transmitting the phase calibration information comprises transmitting the phase calibration information based on a change in an estimated phase error satisfying a phase error change threshold. In a fifteenth aspect, alone or in combination with one or more of the first through fourteenth aspects, the phase error calibration vector includes a plurality of elements, each of the plurality of elements corresponding to a respective transmission port of the plurality of transmission ports. In a sixteenth aspect, alone or in combination with the fifteenth aspect, each element is quantized into a quantity of bits, the method further comprising transmitting an indication communication that indicates the quantity of bits. In a seventeenth aspect, alone or in combination with one or more of the fifteenth or sixteenth aspects, transmitting the phase calibration information comprises transmitting a phase calibration report, wherein the phase calibration report is based on a report configuration. In an eighteenth aspect, alone or in combination with one or more of the fifteenth through seventeenth aspects, a parameter associated with the report configuration is based on at least one of a minimum phase value, a maximum phase value, a fixed quantity of bits, or a one-bit quantization for a sign of a transmission phase. In a nineteenth aspect, alone or in combination with the eighteenth aspect, the parameter comprises at least one of a range or a granularity.

In a twentieth aspect, alone or in combination with one or more of the fifteenth through nineteenth aspects, transmitting the phase calibration information comprises transmitting a first phase calibration report indicative of the phase error calibration vector, and transmitting a second phase calibration report indicative of a set of differential values associated with the phase error calibration vector and an additional phase error calibration vector.

In a twenty-first aspect, alone or in combination with one or more of the first through twentieth aspects, the communication comprises a PUSCH communication.

Although FIG. 8 shows example blocks of process 800, in some aspects, process 800 may include additional blocks, fewer blocks, different blocks, or differently arranged blocks than those depicted in FIG. 8. Additionally, or alternatively, two or more of the blocks of process 800 may be performed in parallel.

FIG. 9 is a diagram of an example apparatus 900 for wireless communication, in accordance with the present disclosure. The apparatus 900 may be a network node, or a network node may include the apparatus 900. In some aspects, the apparatus 900 includes a reception component 902 and a transmission component 904, which may be in communication with one another (for example, via one or more buses and/or one or more other components). As shown, the apparatus 900 may communicate with another apparatus 906 (such as a UE, a base station, another network node, or another wireless communication device) using the reception component 902 and the transmission component 904. As further shown, the apparatus 900 may include a communication manager 908.

In some aspects, the apparatus 900 may be configured to perform one or more operations described herein in connection with FIG. 6. Additionally, or alternatively, the apparatus 900 may be configured to perform one or more processes described herein, such as process 700 of FIG. 7, process 800 of FIG. 8, or a combination thereof. In some aspects, the apparatus 900 and/or one or more components shown in FIG. 9 may include one or more components of the UE and/or the network node described in connection with FIG. 2. Additionally, or alternatively, one or more components shown in FIG. 9 may be implemented within one or more components described in connection with FIG. 2. Additionally, or alternatively, one or more components of the set of components may be implemented at least in part as software stored in a memory. For example, a component (or a portion of a component) may be implemented as instructions or code stored in a non-transitory computer-readable medium and executable by a controller or a processor to perform the functions or operations of the component.

The reception component 902 may receive communications, such as reference signals, control information, data communications, or a combination thereof, from the apparatus 906. The reception component 902 may provide received communications to one or more other components of the apparatus 900. In some aspects, the reception component 902 may perform signal processing on the received communications (such as filtering, amplification, demodulation, analog-to-digital conversion, demultiplexing, deinterleaving, de-mapping, equalization, interference cancellation, or decoding, among other examples), and may provide the processed signals to the one or more other components of the apparatus 900. In some aspects, the reception component 902 may include one or more antennas, a modem, a demodulator, a MIMO detector, a receive processor, a controller/processor, a memory, or a combination thereof, of the UE and/or the network node described in connection with FIG. 2.

The transmission component 904 may transmit communications, such as reference signals, control information, data communications, or a combination thereof, to the apparatus 906. In some aspects, one or more other components of the apparatus 900 may generate communications and may provide the generated communications to the transmission component 904 for transmission to the apparatus 906. In some aspects, the transmission component 904 may perform signal processing on the generated communications (such as filtering, amplification, modulation, digital-to-analog conversion, multiplexing, interleaving, mapping, or encoding, among other examples), and may transmit the processed signals to the apparatus 906. In some aspects, the transmission component 904 may include one or more antennas, a modem, a modulator, a transmit MIMO processor, a transmit processor, a controller/processor, a memory, or a combination thereof, of the UE and/or the network node described in connection with FIG. 2. In some aspects, the transmission component 904 may be co-located with the reception component 902 in a transceiver.

In some examples, means for transmitting, outputting, or sending (or means for outputting for transmission) may include one or more antennas, a modulator, a transmit MIMO processor, a transmit processor, or a combination thereof, of the UE and/or the network node described above in connection with FIG. 2.

In some examples, means for receiving (or means for obtaining) may include one or more antennas, a demodulator, a MIMO detector, a receive processor, or a combination thereof, of the UE and/or the network node described above in connection with FIG. 2.

In some cases, rather than actually transmitting, for example, signals and/or data, a device may have an interface to output signals and/or data for transmission (a means for outputting). For example, a processor may output signals and/or data, via a bus interface, to an RF front end for transmission. Similarly, rather than actually receiving signals and/or data, a device may have an interface to obtain the signals and/or data received from another device (a means for obtaining). For example, a processor may obtain (or receive) the signals and/or data, via a bus interface, from an RF front end for reception. In various aspects, an RF front end may include various components, including transmit and receive processors, transmit and receive MIMO processors, modulators, demodulators, and the like, such as depicted in the examples in FIG. 2.

In some examples, means for transmitting and/or receiving may include various processing system components, such as a receive processor, a transmit processor, a controller/processor, a memory, or a combination thereof, of the UE and/or the network node described above in connection with FIG. 2.

The reception component 902 may receive, from a second network node, phase calibration information indicative of a phase error calibration vector corresponding to a phase difference associated with a plurality of transmission ports at the first network node.

The communication manager 908 and/or the transmission component 904 may transmit a communication based on the phase calibration information. In some aspects, the communication manager 908 may include one or more antennas, a modem, a controller/processor, a memory, or a combination thereof, of the UE and/or the network node described in connection with FIG. 2. In some aspects, the communication manager 908 may include the reception component 902 and/or the transmission component 904. In some aspects, the communication manager 908 may be, be similar to, include, or be included in, the communication manager 140 and/or 150 depicted in FIGS. 1 and 2.

The communication manager 908 and/or the reception component 902 may receive, from the second network node, calibration configuration information indicative of a set of SRS resources for phase error calibration. The communication manager 908 and/or the transmission component 904 may transmit, based on the calibration configuration information, a plurality of SRSs, each SRSs of the plurality of SRSs corresponding to a respective transmission port of the plurality of transmission ports. The communication manager 908 and/or the transmission component 904 may transmit a PUSCH communication based on the phase error calibration vector. The communication manager 908 and/or the reception component 902 may receive an uplink resource grant for transmitting the PUSCH communication, wherein the uplink resource grant indicates at least one of a transmitted precoding matrix indicator or a rank indicator.

The communication manager 908 and/or the transmission component 904 may transmit, to a first network node, phase calibration information indicative of a phase error calibration vector corresponding to a phase difference associated with a plurality of transmission ports at the first network node. The communication manager 908 and/or the reception component 902 may receive a communication based on the phase calibration information. The communication manager 908 and/or the transmission component 904 may transmit, to the first network node, calibration configuration information indicative of a set of SRS resources for phase error calibration.

The communication manager 908 and/or the reception component 902 may receive, based on the calibration configuration information, at least one SRS corresponding to a respective transmission port of the plurality of transmission ports. The communication manager 908 and/or the reception component 902 may receive a PUSCH communication based on the phase error calibration vector. The communication manager 908 and/or the transmission component 904 may transmit an uplink resource grant for transmitting the PUSCH communication, wherein the uplink resource grant indicates at least one of a transmitted precoding matrix indicator or a rank indicator.

The number and arrangement of components shown in FIG. 9 are provided as an example. In practice, there may be additional components, fewer components, different components, or differently arranged components than those shown in FIG. 9. Furthermore, two or more components shown in FIG. 9 may be implemented within a single component, or a single component shown in FIG. 9 may be implemented as multiple, distributed components. Additionally, or alternatively, a set of (one or more) components shown in FIG. 9 may perform one or more functions described as being performed by another set of components shown in FIG. 9.

The following provides an overview of some Aspects of the present disclosure:

Aspect 1: A method of wireless communication performed by an apparatus at a first network node, comprising: receiving, from a second network node, phase calibration information indicative of a phase error calibration vector corresponding to a phase difference associated with a plurality of transmission ports at the first network node; and transmitting a communication based on the phase calibration information.

Aspect 2: The method of Aspect 1, further comprising: receiving, from the second network node, calibration configuration information indicative of a set of sounding reference signal (SRS) resources for phase error calibration; and transmitting, based on the calibration configuration information, a plurality of SRSs, each SRSs of the plurality of SRSs corresponding to a respective transmission port of the plurality of transmission ports.

Aspect 3: The method of Aspect 2, wherein the set of SRS resources comprises at least one of periodic SRS resources or semi-persistent SRS resources.

Aspect 4: The method of either of Aspects 2 or 3, wherein the set of SRS resources corresponds to a bandwidth part.

Aspect 5: The method of any of Aspects 2-4, wherein the set of SRS resources comprises dedicated resources for transmission phase estimation.

Aspect 6: The method of any of Aspects 2-5, wherein the set of SRS resources is configured for downlink channel state information acquisition.

Aspect 7: The method of any of Aspects 2-6, wherein the set of SRS resources is configured for codebook-based physical uplink shared channel communication.

Aspect 8: The method of any of Aspects 1-7, wherein the communication comprises a sounding reference signal (SRS).

Aspect 9: The method of Aspect 8, wherein the SRS is based on the phase error calibration vector and corresponds to a codebook-based physical uplink shared channel (PUSCH) operation.

Aspect 10: The method of Aspect 9, further comprising transmitting a PUSCH communication based on the phase error calibration vector.

Aspect 11: The method of Aspect 10, further comprising receiving an uplink resource grant for transmitting the PUSCH communication, wherein the uplink resource grant indicates at least one of a transmitted precoding matrix indicator or a rank indicator.

Aspect 12: The method of any of Aspects 1-11, wherein receiving the phase calibration information comprises receiving a medium access control control element (MAC CE) via a physical downlink shared channel.

Aspect 13: The method of any of Aspects 1-12, wherein receiving the phase calibration information comprises receiving a plurality of periodic communications, wherein a first periodic communication of the plurality of periodic communications includes first phase calibration information of the phase calibration information and a second periodic communication of the plurality of periodic communications includes second phase calibration information of the phase calibration information.

Aspect 14: The method of any of Aspects 1-13, wherein receiving the phase calibration information comprises receiving an aperiodic communication.

Aspect 15: The method of Aspect 14, wherein receiving the phase calibration information comprises receiving the phase calibration information based on a change in an estimated phase error satisfying a phase error change threshold.

Aspect 16: The method of any of Aspects 1-15, wherein the phase error calibration vector includes a plurality of elements, each of the plurality of elements corresponding to a respective transmission port of the plurality of transmission ports.

Aspect 17: The method of Aspect 16, wherein each element is quantized into a quantity of bits, the method further comprising obtaining the quantity of bits based on at least one of an indication communication or information stored in a memory of the first network node.

Aspect 18: The method of either of Aspects 16 or 17, wherein receiving the phase calibration information comprises receiving a phase calibration report, wherein the phase calibration report is based on a report configuration.

Aspect 19: The method of Aspect 18, wherein a parameter associated with the report configuration is based on at least one of: a minimum phase value, a maximum phase value, a fixed quantity of bits, or a one-bit quantization for a sign of a transmission phase.

Aspect 20: The method of Aspect 19, wherein the parameter comprises at least one of a range or a granularity.

Aspect 21: The method of any of Aspects 16-20, wherein receiving the phase calibration information comprises: receiving a first phase calibration report indicative of the phase error calibration vector; and receiving a second phase calibration report indicative of a set of differential values associated with the phase error calibration vector and an additional phase error calibration vector.

Aspect 22: The method of any of Aspects 1-21, wherein the communication comprises a physical uplink shared channel (PUSCH) communication.

Aspect 23: A method of wireless communication performed by an apparatus at a second network node, comprising: transmitting, to a first network node, phase calibration information indicative of a phase error calibration vector corresponding to a phase difference associated with a plurality of transmission ports at the first network node; and receiving a communication based on the phase calibration information.

Aspect 24: The method of Aspect 23, further comprising: transmitting, to the first network node, calibration configuration information indicative of a set of sounding reference signal (SRS) resources for phase error calibration; and receiving, based on the calibration configuration information, at least one SRS corresponding to a respective transmission port of the plurality of transmission ports.

Aspect 25: The method of Aspect 24, wherein the set of SRS resources comprises at least one of periodic SRS resources or semi-persistent SRS resources.

Aspect 26: The method of either of Aspects 24 or 25, wherein the set of SRS resources corresponds to a bandwidth part.

Aspect 27: The method of any of Aspects 24-26, wherein the set of SRS resources comprises dedicated resources for transmission phase estimation.

Aspect 28: The method of any of Aspects 24-27, wherein the set of SRS resources is configured for downlink channel state information acquisition.

Aspect 29: The method of any of Aspects 24-28, wherein the set of SRS resources is configured for codebook-based physical uplink shared channel communication.

Aspect 30: The method of any of Aspects 23-29, wherein the communication comprises a sounding reference signal (SRS).

Aspect 31: The method of Aspect 30, wherein the SRS is based on the phase error calibration vector and corresponds to a codebook-based physical uplink shared channel (PUSCH) operation.

Aspect 32: The method of Aspect 31, further comprising receiving a PUSCH communication based on the phase error calibration vector.

Aspect 33: The method of Aspect 32, further comprising transmitting an uplink resource grant for transmitting the PUSCH communication, wherein the uplink resource grant indicates at least one of a transmitted precoding matrix indicator or a rank indicator.

Aspect 34: The method of any of Aspects 23-33, wherein transmitting the phase calibration information comprises transmitting a medium access control control element (MAC CE) via a physical downlink shared channel.

Aspect 35: The method of any of Aspects 23-34, wherein transmitting the phase calibration information comprises transmitting a plurality of periodic communications, wherein a first periodic communication of the plurality of periodic communications includes first phase calibration information of the phase calibration information and a second periodic communication of the plurality of periodic communications includes second phase calibration information of the phase calibration information.

Aspect 36: The method of any of Aspects 23-34, wherein transmitting the phase calibration information comprises transmitting an aperiodic communication.

Aspect 37: The method of Aspect 36, wherein transmitting the phase calibration information comprises transmitting the phase calibration information based on a change in an estimated phase error satisfying a phase error change threshold.

Aspect 38: The method of any of Aspects 23-37, wherein the phase error calibration vector includes a plurality of elements, each of the plurality of elements corresponding to a respective transmission port of the plurality of transmission ports.

Aspect 39: The method of Aspect 38, wherein each element is quantized into a quantity of bits, the method further comprising transmitting an indication communication that indicates the quantity of bits.

Aspect 40: The method of either of Aspects 38 or 39, wherein transmitting the phase calibration information comprises transmitting a phase calibration report, wherein the phase calibration report is based on a report configuration.

Aspect 41: The method of any of Aspects 38-40, wherein a parameter associated with the report configuration is based on at least one of: a minimum phase value, a maximum phase value, a fixed quantity of bits, or a one-bit quantization for a sign of a transmission phase.

Aspect 42: The method of Aspect 41, wherein the parameter comprises at least one of a range or a granularity.

Aspect 43: The method of any of Aspects 38-42, wherein transmitting the phase calibration information comprises: transmitting a first phase calibration report indicative of the phase error calibration vector; and transmitting a second phase calibration report indicative of a set of differential values associated with the phase error calibration vector and an additional phase error calibration vector.

Aspect 44: The method of any of Aspects 23-43, wherein the communication comprises a physical uplink shared channel (PUSCH) communication.

Aspect 45: An apparatus for wireless communication at a device, comprising a processor; memory coupled with the processor; and instructions stored in the memory and executable by the processor to cause the apparatus to perform the method of one or more of Aspects 1-22.

Aspect 46: A device for wireless communication, comprising a memory and one or more processors coupled to the memory, the one or more processors configured to perform the method of one or more of Aspects 1-22.

Aspect 47: An apparatus for wireless communication, comprising at least one means for performing the method of one or more of Aspects 1-22.

Aspect 48: A non-transitory computer-readable medium storing code for wireless communication, the code comprising instructions executable by a processor to perform the method of one or more of Aspects 1-22.

Aspect 49: A non-transitory computer-readable medium storing a set of instructions for wireless communication, the set of instructions comprising one or more instructions that, when executed by one or more processors of a device, cause the device to perform the method of one or more of Aspects 1-22.

Aspect 50: An apparatus for wireless communication at a device, comprising a processor; memory coupled with the processor; and instructions stored in the memory and executable by the processor to cause the apparatus to perform the method of one or more of Aspects 23-44.

Aspect 51: A device for wireless communication, comprising a memory and one or more processors coupled to the memory, the one or more processors configured to perform the method of one or more of Aspects 23-44.

Aspect 52: An apparatus for wireless communication, comprising at least one means for performing the method of one or more of Aspects 23-44.

Aspect 53: A non-transitory computer-readable medium storing code for wireless communication, the code comprising instructions executable by a processor to perform the method of one or more of Aspects 23-44.

Aspect 54: A non-transitory computer-readable medium storing a set of instructions for wireless communication, the set of instructions comprising one or more instructions that, when executed by one or more processors of a device, cause the device to perform the method of one or more of Aspects 23-44.

The foregoing disclosure provides illustration and description but is not intended to be exhaustive or to limit the aspects to the precise forms disclosed. Modifications and variations may be made in light of the above disclosure or may be acquired from practice of the aspects.

As used herein, the term “component” is intended to be broadly construed as hardware and/or a combination of hardware and software. “Software” shall be construed broadly to mean instructions, instruction sets, code, code segments, program code, programs, subprograms, software modules, applications, software applications, software packages, routines, subroutines, objects, executables, threads of execution, procedures, and/or functions, among other examples, whether referred to as software, firmware, middleware, microcode, hardware description language, or otherwise. As used herein, a “processor” is implemented in hardware and/or a combination of hardware and software. It will be apparent that systems and/or methods described herein may be implemented in different forms of hardware and/or a combination of hardware and software. The actual specialized control hardware or software code used to implement these systems and/or methods is not limiting of the aspects. Thus, the operation and behavior of the systems and/or methods are described herein without reference to specific software code, since those skilled in the art will understand that software and hardware can be designed to implement the systems and/or methods based, at least in part, on the description herein.

As used herein, “satisfying a threshold” may, depending on the context, refer to a value being greater than the threshold, greater than or equal to the threshold, less than the threshold, less than or equal to the threshold, equal to the threshold, not equal to the threshold, or the like.

Even though particular combinations of features are recited in the claims and/or disclosed in the specification, these combinations are not intended to limit the disclosure of various aspects. Many of these features may be combined in ways not specifically recited in the claims and/or disclosed in the specification. The disclosure of various aspects includes each dependent claim in combination with every other claim in the claim set. As used herein, a phrase referring to “at least one of” a list of items refers to any combination of those items, including single members. As an example, “at least one of: a, b, or c” is intended to cover a, b, c, a+b, a+c, b+c, and a+b+c, as well as any combination with multiples of the same element (e.g., a+a, a+a+a, a+a+b, a+a+c, a+b+b, a+c+c, b+b, b+b+b, b+b+c, c+c, and c+c+c, or any other ordering of a, b, and c).

No element, act, or instruction used herein should be construed as critical or essential unless explicitly described as such. Also, as used herein, the articles “a” and “an” are intended to include one or more items and may be used interchangeably with “one or more.” Further, as used herein, the article “the” is intended to include one or more items referenced in connection with the article “the” and may be used interchangeably with “the one or more.” Furthermore, as used herein, the terms “set” and “group” are intended to include one or more items and may be used interchangeably with “one or more.” Where only one item is intended, the phrase “only one” or similar language is used. Also, as used herein, the terms “has,” “have,” “having,” or the like are intended to be open-ended terms that do not limit an element that they modify (e.g., an element “having” A may also have B). Further, the phrase “based on” is intended to mean “based, at least in part, on” unless explicitly stated otherwise. Also, as used herein, the term “or” is intended to be inclusive when used in a series and may be used interchangeably with “and/or,” unless explicitly stated otherwise (e.g., if used in combination with “either” or “only one of”).

1. A first network node for wireless communication, comprising:
memory; and
one or more processors coupled with the memory and configured to cause the first network node to:
receive, from a second network node, phase calibration information indicative of a phase error calibration vector corresponding to a phase difference associated with a plurality of transmission ports at the first network node; and
transmit a communication based on the phase calibration information.

2. The first network node of claim 1, wherein the one or more processors are further configured to:
receive, from the second network node, calibration configuration information indicative of a set of sounding reference signal (SRS) resources for phase error calibration; and
transmit, based on the calibration configuration information, a plurality of SRSs, each SRSs of the plurality of SRSs corresponding to a respective transmission port of the plurality of transmission ports.

3. The first network node of claim 2, wherein the set of SRS resources comprises at least one of:
periodic SRS resources;
semi-persistent SRS resources; or
dedicated resources for transmission phase estimation.

4. (canceled)

5. (canceled)

6. The first network node of claim 2, wherein the set of SRS resources is configured for downlink channel state information acquisition or codebook-based physical uplink shared channel communication.

7. (canceled)

8. The first network node of claim 1, wherein the communication comprises a sounding reference signal (SRS), wherein the SRS is based on the phase error calibration vector and corresponds to a codebook-based physical uplink shared channel (PUSCH) operation.

9. (canceled)

10. The first network node of claim 8, wherein the one or more processors are further configured to cause the first network node to transmit a PUSCH communication based on the phase error calibration vector; and
wherein the one or more processors are further configured to cause the first network node to receive an uplink resource grant for transmitting the PUSCH communication, wherein the uplink resource grant indicates at least one of a transmitted precoding matrix indicator or a rank indicator.

11. (canceled)

12. The first network node of claim 1, wherein the one or more processors, to cause the first network node to receive the phase calibration information, are configured to cause the first network node to receive a medium access control control element (MAC CE) via a physical downlink shared channel.

13. The first network node of claim 1, the one or more processors, to cause the first network node to receive the phase calibration information, are configured to cause the first network node to receive a plurality of periodic communications, wherein a first periodic communication of the plurality of periodic communications includes first phase calibration information of the phase calibration information and a second periodic communication of the plurality of periodic communications includes second phase calibration information of the phase calibration information.

14. The first network node of claim 1, wherein the one or more processors, to cause the first network node to receive the phase calibration information, are configured to cause the first network node to receive an aperiodic communication.

15. The first network node of claim 14, wherein the one or more processors, to cause the first network node to receive the phase calibration information, are configured to cause the first network node to receive the phase calibration information based on a change in an estimated phase error satisfying a phase error change threshold.

16. The first network node of claim 1, wherein the phase error calibration vector includes a plurality of elements, each of the plurality of elements corresponding to a respective transmission port of the plurality of transmission ports.

17. The first network node of claim 16, wherein each element is quantized into a quantity of bits, wherein the one or more processors are further configured to cause the first network node to obtain the quantity of bits based on at least one of an indication communication or information stored in memory of the first network node.

18. The first network node of claim 16, wherein the one or more processors, to cause the first network node to receive the phase calibration information, are configured to receive a phase calibration report, wherein the phase calibration report is based on a report configuration.

19. The first network node of claim 18, wherein a parameter associated with the report configuration is based on at least one of:
a minimum phase value,
a maximum phase value,
a fixed quantity of bits, or
a one-bit quantization for a sign of a transmission phase.

20. The first network node of claim 19, wherein the parameter comprises at least one of a range or a granularity.

21. The first network node of claim 16, wherein the one or more processors, to cause the first network node to receive the phase calibration information, are configured to cause the first network node to:
receive a first phase calibration report indicative of the phase error calibration vector; and
receive a second phase calibration report indicative of a set of differential values associated with the phase error calibration vector and an additional phase error calibration vector.

22. (canceled)

23. A second network node, for wireless communication, comprising:
memory; and
one or more processors coupled with the memory and configured to cause the second network node to:
transmit, to a first network node, phase calibration information indicative of a phase error calibration vector corresponding to a phase difference associated with a plurality of transmission ports at the first network node; and
receive a communication based on the phase calibration information.

24. The second network node of claim 23, wherein the one or more processors are further configured to cause the second network node to:
transmit, to the first network node, calibration configuration information indicative of a set of sounding reference signal (SRS) resources for phase error calibration; and
receive, based on the calibration configuration information, at least one SRS corresponding to a respective transmission port of the plurality of transmission ports.

25. (canceled)

26. (canceled)

27. A method of wireless communication performed by an apparatus at a first network node, comprising:
receiving, from a second network node, phase calibration information indicative of a phase error calibration vector corresponding to a phase difference associated with a plurality of transmission ports at the first network node; and
transmitting a communication based on the phase calibration information.

28. The method of claim 27, further comprising:
receiving, from the second network node, calibration configuration information indicative of a set of sounding reference signal (SRS) resources for phase error calibration; and
transmitting, based on the calibration configuration information, a plurality of SRSs, each SRSs of the plurality of SRSs corresponding to a respective transmission port of the plurality of transmission ports.

29. (canceled)

30. (canceled)
